(19) United States
(12) Patent Application Publication
(10) Pub. No.: US 2025/0208332 A1
(43) Pub. Date: Jun. 26, 2025

(54) LIGHT GUIDE PLATE, DISPLAY DEVICE, GAMING MACHINE, AND IN-VEHICLE DISPLAYER

(71) Applicant: OMRON Corporation, KYOTO (JP)

(72) Inventors: Yuto MORI, Kyoto-shi (JP); Masayuki SHINOHARA, Kyoto-shi (JP)

(73) Assignee: OMRON Corporation, KYOTO (JP)

(21) Appl. No.: 18/940,765

(22) Filed: Nov. 7, 2024

(30) Foreign Application Priority Data
Dec. 20, 2023 (JP) 2023-215016

(51) Int. Cl. F21V 8/00; G02B 30/30

(52) U.S. Cl. CPC G02B 6/0038; G02B 30/30

(57) ABSTRACT

A light guide plate includes an incident surface into which light from a light source is incident, an emission surface from which the light is emitted, and a plurality of light deflectors that cause the light to be incident from the incident surface and guided therein to be emitted from the emission surface, the plurality of light deflectors being disposed on an arrangement line which is a linear arrangement region, and at least one of the arrangement lines is a multi-intersection arrangement line.

### CROSS-REFERENCE TO RELATED APPLICATION

This application claims the priority benefits of Japanese application no. 2023-215016, filed on Dec. 20, 2023. The entity of the above-mentioned patent application is hereby incorporated by reference herein and made a part of this specification.

### BACKGROUND

### Technical Field

The disclosure relates to a light guide plate, a display device, a gaming machine, and an in-vehicle displayer that display a stereoscopic image based on parallax.

### Related Art

Patent Document 1 discloses a light guide plate that displays a stereoscopic image based on parallax. The light guide plate has a plurality of deflectors with inclined surfaces in each row parallel to an incident surface, where light from the light source is incident through the incident surface, which is a side surface, and where the light is guided while being totally reflected inside, and is reflected and emitted from the emission surface. The orientation of the inclined surface of each row changes according to the distance from the incident surface.

### CITATION LIST

### Patent Document

Patent Document 1 Japanese Patent Laid-open No. 2019-139176

However, as will be described in detail later, in the light guide plate of Patent Document 1, in a region where a stereoscopic image nearly parallel to the incident surface is displayed, a row spacing of a deflector for displaying the stereoscopic image needs to be narrowed. In such a region, the density of the deflectors increases, which causes a problem of reducing the transparency of the light guide plate. Furthermore, when it is desired to display a stereoscopic image with an extremely high degree of parallelism with respect to the incident surface, there is a problem in that it becomes difficult to display the stereoscopic image as a continuous line image.

An object of one embodiment of the disclosure is to provide a light guide plate or the like capable of clearly displaying a stereoscopic image nearly parallel to the incident surface.

### SUMMARY

A light guide plate according to one aspect of the disclosure is a light guide plate for displaying a stereoscopic image based on parallax. The light guide palate includes: an incident surface on which light from a light source is incident; an emission surface from which the light is emitted; and a plurality of light deflectors that deflect the light that is incident from the incident surface and guided and cause it to be emitted from the emission surface. The plurality of light deflectors are disposed on an arrangement line which is a linear arrangement region. When a point on the emission surface from which a first emission light deflected by the light deflector is emitted into an angular range in which one eye and its vicinity of an observer observing the emission surface from within a predetermined range of observation space is irradiated is taken as a first emission point, and a point on the emission surface from which a second emission light deflected by the light deflector is emitted into an angular range in which the other eye and its vicinity of the observer is irradiated is taken as a second emission point, the plurality of light deflectors disposed on the arrangement line are provided such that a straight line passing through the first emission point and a center of the one eye and a straight line passing through the second emission point and a center of the other eye intersect with each other to form an intersection point. A plurality of the arrangement lines are provided, and at least one of the arrangement lines is a multi-intersection arrangement line in which the plurality of light deflectors are provided such that the intersection point is formed at multiple positions for each of the positions of the one eye and the other eye.

A display device according to one aspect of the disclosure includes the light guide plate, a plurality of light sources that cause light to be incident on the light guide plate from the incident surface, and a controller that controls the plurality of light sources.

A gaming machine according to one aspect of the disclosure includes the display device.

An in-vehicle displayer according to one aspect of the disclosure includes the display device.

### BRIEF DESCRIPTION OF THE DRAWINGS

FIG. 1 is a plan view illustrating a configuration of a display device according to an Embodiment 1.

FIG. 2 is a cross-sectional view showing a path of light guided by a light guide plate according to the Embodiment 1.

FIG. 3 is a perspective view for describing the directivity of emission light emitted from an emission surface of the light guide plate according to the Embodiment 1.

FIG. 4 illustrates the principle of stereoscopic display based on parallax, and is a perspective view showing the intersection point where a straight line passing through a first emission point and the center of one of the observer's eyes intersects with a straight line passing through a second emission point and the center of the other observer's eye.

FIG. 5 is a perspective view showing a gaming machine equipped with a display device according to the Embodiment 1.

FIG. 6 is a diagram for describing light deflected by a light deflector on a multi-intersection arrangement line.

FIG. 7 is a diagram illustrating a specific example of the arrangement of light deflectors in the light guide plate according to the Embodiment 1.

FIG. 8 is a diagram illustrating a more specific example of the arrangement of light deflectors in the light guide plate according to the Embodiment 1.

FIG. 9 is a diagram illustrating a specific example of the shape of light deflector disposed on a multi-intersection arrangement line.

FIG. 10 is a diagram illustrating an example of a stereoscopic image displayed by the light deflector shown in FIG. 9.

FIG. 11 is a diagram illustrating a specific example of the shape of the light deflector other than that shown in FIG. 10.

FIG. 12 is a diagram illustrating an example of a stereoscopic image displayed by the light deflector shown in FIG. 11.

FIG. 13 is a diagram for describing the directivity of light by a light deflector.

FIG. 14 is a diagram illustrating a specific example of the shape of the light deflector other than those shown in FIG. 10 and FIG. 12.

FIG. 15 is a diagram illustrating an example of a stereoscopic image displayed by the light deflector shown in FIG. 14.

FIG. 16 is a diagram for describing still another example of the shape of the light deflector.

FIG. 17 is a diagram for describing a light deflector according to a first modified example of the Embodiment 1.

FIG. 18 is a diagram for describing a light deflector according to a second modified example of the Embodiment 1.

FIG. 19 is a diagram for describing a light deflector according to a third modified example of the Embodiment 1.

FIG. 20 is a diagram illustrating an example of a light deflector in a region where the width of a stereoscopic image in a direction along a multi-intersection arrangement line is wide.

FIG. 21 is a diagram illustrating an example of a display device according to an Embodiment 2.

FIG. 22 is a diagram for describing the direction in which the light deflector deflects light in the light guide plate according to the Embodiment 2.

FIG. 23 is a diagram for describing a display device according to a first modified example of the Embodiment 2.

FIG. 24 is a diagram for describing a display device according to a second modified example of the Embodiment 2.

FIG. 25 is a plan view illustrating an example of a display device according to an Embodiment 3.

FIG. 26 is a plan view illustrating an example of a display device according to an Embodiment 4.

FIG. 27 is a plan view illustrating another example of the display device according to the Embodiment 4.

FIG. 28 is a plan view illustrating yet another example of the display device according to the Embodiment 4.

FIG. 29 is a plan view illustrating a display device according to a first modified example of the Embodiment 4.

FIG. 30 is a plan view illustrating a display device according to a second modified example of the Embodiment 4.

FIG. 31 is a plan view illustrating a display device according to a third modified example of the Embodiment 4.

FIG. 32 is a diagram illustrating display devices according to an Embodiment 5.

FIG. 33 is a diagram illustrating display devices according to a modified example of the Embodiment 5.

FIG. 34 is a diagram illustrating display devices according to another modified example of the Embodiment 4, different from the one shown in FIG. 33.

FIG. 35 is a plan view illustrating an example of an arrangement line according to an Embodiment 6.

FIG. 36 is a plan view illustrating an example of a light guide plate according to the Embodiment 6.

FIG. 37 is a plan view illustrating an example of an arrangement line according to an Embodiment 7.

FIG. 38 is a plan view illustrating an example of a light guide plate according to the Embodiment 7.

FIG. 39 is a plan view illustrating an example of an arrangement line according to an Embodiment 8.

FIG. 40 is a plan view illustrating an example of a light guide plate according to the Embodiment 8.

### DESCRIPTION OF THE EMBODIMENTS

A light guide plate according to one aspect of the disclosure is a light guide plate for displaying a stereoscopic image based on parallax. The light guide palate includes: an incident surface on which light from a light source is incident; an emission surface from which the light is emitted; and a plurality of light deflectors that deflect the light that is incident from the incident surface and guided and cause it to be emitted from the emission surface. The plurality of light deflectors are disposed on an arrangement line which is a linear arrangement region. When a point on the emission surface from which a first emission light deflected by the light deflector is emitted into an angular range in which one eye and its vicinity of an observer observing the emission surface from within a predetermined range of observation space is irradiated is taken as a first emission point, and a point on the emission surface from which a second emission light deflected by the light deflector is emitted into an angular range in which the other eye and its vicinity of the observer is irradiated is taken as a second emission point, the plurality of light deflectors disposed on the arrangement line are provided such that a straight line passing through the first emission point and a center of the one eye and a straight line passing through the second emission point and a center of the other eye intersect with each other to form an intersection point. A plurality of the arrangement lines are provided, and at least one of the arrangement lines is a multi-intersection arrangement line in which the plurality of light deflectors are provided such that the intersection point is formed at multiple positions for each of the positions of the one eye and the other eye.

According to the configuration, light deflected by the light deflector provided on the multi-intersection arrangement line forms intersection points at multiple positions for each of the positions of one eye and the other eye of the observer. Thus, the observer visually recognizes light from a plurality of light deflectors provided on the multi-intersection arrangement line for each of the positions of one eye and the other eye. At this time, the observer visually recognizes the light as light within a region having a width in the direction along the multi-intersection arrangement line. Thus, it is possible to display a stereoscopic image nearly parallel to the incident surface clearly.

Furthermore, in a light guide plate according to one aspect of the disclosure,
each of the plurality of light deflectors has a light deflection surface that deflects the light, and the light deflection surface of the light deflector disposed on the multi-intersection arrangement line is a curved surface in which a direction in which the light emitted from one of the light source is deflected changes continuously from a first direction toward a first position in the observation space to a second direction toward a second position different from the first position.

According to the configuration, an observer perceives the light from the plurality of light deflectors disposed on the multi-intersection arrangement line as continuous light from the first direction to the second direction in a direction along the multi-intersection arrangement line. Thus, it is possible to display a continuous stereoscopic image clearly in the direction along the multi-intersection arrangement line.

Moreover, in a light guide plate according to one embodiment of the disclosure, a minimum value of light amount deflected by the light deflectors disposed on the multi-intersection arrangement line in accordance with a direction in which the light is deflected is 0.7 times or more a maximum value of the light amount.

According to the configuration, it is possible to make an observer recognize a stereoscopic image that is continuous in the direction along the multi-intersection arrangement line as an image having a substantially constant light amount.

Furthermore, in a light guide plate according to one embodiment of the disclosure, an average light amount in an outer peripheral region of the stereoscopic image, of the light deflected by the light deflectors disposed on the multi-intersection arrangement line, is twice or more an average light amount in a region more inside of the stereoscopic image than the outer peripheral region, of the light deflected by the light deflectors disposed on the multi-intersection arrangement line.

According to the configuration, it is possible to emphasize the contours of a stereoscopic image.

Furthermore, in a light guide plate according to one aspect of the disclosure, the light deflector includes a first light deflector in which a curvature of the curved surface is a first curvature and a second light deflector in which the curvature is a second curvature different from the first curvature, and a middle region is provided between a first light deflection region in which the first light deflector is disposed and a second light deflection region in which the second light deflector is disposed, in which the first light deflector and the second light deflector are disposed in a randomly mixed state.

According to the configuration, the point where the curvature of the curved surface of the light deflector changes is less likely to be visually recognized by the observer.

Furthermore, in alight guide plate according to one aspect of the disclosure, light amount of the light deflected by each of the plurality of light deflectors is constant for each of the multi-intersection arrangement lines on which the light deflectors are disposed, and when a middle value in the middle of a maximum value and a minimum value of the light amount deflected by the light deflectors in a reference direction which is a direction in the middle of the first direction and the second direction is taken as a middle value, the minimum value is 0.7 times or more the middle value, and the maximum value is 1.3 times or less the middle value.

According to the configuration, even if the width of the stereoscopic image differs for each of the multi-intersection arrangement lines, the observer visually recognize the light amount as being approximately constant.

Furthermore, in a light guide plate according to one aspect of the disclosure, each of the light deflectors has a light deflection surface that deflects the light, and directions in which the light deflection surfaces of the plurality of light deflectors disposed on the multi-intersection arrangement line deflect the light are dispersed between a first direction toward a first position in the observation space and a second direction toward a second position different from the first position.

According to the configuration, an observer perceives light from the plurality of light deflectors disposed on the multi-intersection arrangement line as intermittent light between a first direction and a second direction in a direction along the multi-intersection arrangement line. Thus, it is possible to display a stereoscopic image intermittently between the first direction and the second direction along the multi-intersection arrangement line.

Moreover, in a light guide plate according to one aspect of the disclosure, a directions in which the light deflection surfaces of each of the plurality of light deflectors deflect the light are randomly dispersed between the first direction and the second direction.

According to the configuration, rendition in which the light blinks randomly between a first direction and a second direction in response to a change in the observation position is possible.

Moreover, in a light guide plate according to one embodiment of the disclosure, the plurality of light deflectors include: a first light deflector group which is a collection of the light deflectors that deflect the light in the first direction with respect to the one eye and the other eye at any position; a second light deflector group which is a collection of the light deflectors that deflect the light in the second direction with respect to the one eye and the other eye at any position; and a third light deflector group which is a collection of the light deflectors that deflect the light in a random direction between the first direction and the second direction.

According to the configuration, the light deflectors included in the first light deflector group and the second light deflector group deflect light in the first direction and the second direction, regardless of the observation position. Moreover, the light deflectors included in the third light deflector group deflect the light in a random direction between the first direction and the second direction according to the observation position. This allows rendition in which the contour is displayed at all times, while the inside of the contour blinks randomly.

Moreover, in a light guide plate according to one embodiment of the disclosure, there is a positive correlation between a width of the stereoscopic image in a direction corresponding to a direction along the multi-intersection arrangement line and a number of the light deflectors disposed along the multi-intersection arrangement line.

According to the configuration, it is possible to reduce the variation in the light amount caused by the variation in the width of the stereoscopic image.

A display device according to one aspect of the disclosure includes the light guide plate, a plurality of light sources that cause light to be incident on the light guide plate from the incident surface, and a controller that controls the plurality of light sources.

According to the configuration, the controller controls the plurality of light sources, thereby making it possible to change the position of the light source that makes light incident on the light guide plate.

Moreover, in a display device according to one aspect of the disclosure, the plurality of light sources may be linearly arranged, and the controller may control the plurality of light sources to be turned on and off sequentially from one end of the linear arrangement to the other end.

According to the configuration, it is possible to realize control such that the position of the light source that causes light to be incident on the light guide plate moves from one end to the other end of the region in which the plurality of light sources are linearly arranged.

Moreover, in a display device according to one aspect of the disclosure, the plurality of light sources may be linearly arranged, and the controller may control the plurality of light sources to be turned on and off sequentially from any point other than one end and the other end of the linear arrangement to both the one end and the other end.

According to the configuration, it is possible to realize control such that the positions of the light sources that cause light to be incident on the light guide plate move from other than both ends to both ends of the region in which the plurality of light sources are linearly arranged.

Moreover, a gaming machine according to one aspect of the disclosure includes the display device.

According to the configuration, the same effects as those of the display device are achieved.

Moreover, an in-vehicle displayer according to one aspect of the disclosure includes the display device.

According to the configuration, the same effects as those of the display device are achieved.

According to one aspect of the disclosure, it is possible to realize a light guide plate or the like that is capable of clearly displaying a stereoscopic image nearly parallel to the incident surface.

### Embodiment 1

Hereinafter, one embodiment of the disclosure will be described in detail. In the following description, “A to B” indicating a numerical range means “A or more and B or less” unless otherwise specified. Moreover, in each drawing, when there are a plurality of elements that should be given the same reference numerals, reference numerals may be given to only some of them.

### Example of Application

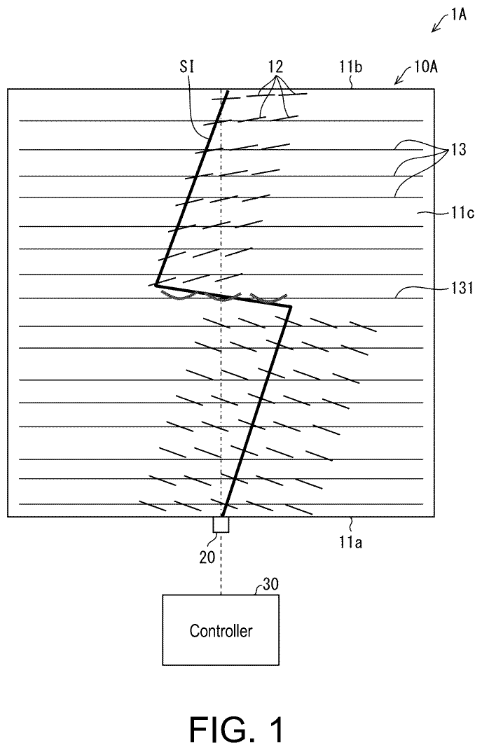

FIG. 1 is a plan view illustrating a configuration of a display device 1A according to one embodiment of the disclosure. First, an example of a situation to which the disclosure is applied will be described with reference to FIG. 1. As shown in FIG. 1, the display device 1A according to the disclosure includes a light guide plate 10A, a light source 20, and a controller 30. For simplicity, the controller 30 is omitted in drawings other than FIG. 1.

The light guide plate 10A displays a stereoscopic image SI based on parallax. In this example of application, the light guide plate 10A has a rectangular plate shape in a plan view. In other words, the light guide plate 10A has a rectangular parallelepiped shape. However, the shape of the light guide plate 10A is not limited thereto. The material of the light guide plate 10A may be, for example, polycarbonate, acrylic, other light-transmitting resin, or glass.

The stereoscopic image SI includes one or more line segments or curves. The stereoscopic image SI expresses characters, drawings, pictures, etc., by a combination of line segments or curves.

The light guide plate 10A has an incident surface 11a. The incident surface 11a is a surface through which light from the light source 20 is incident on the light guide plate 10A. The incident surface 11a is one of the side surfaces of the light guide plate 10A having a rectangular parallelepiped shape. When a surface with the largest area in the rectangular parallelepiped shape is called the main surface, the side surface is the surface adjacent to the main surface.

The light guide plate 10A also has another side surface 11b opposite to the incident surface 11a. In the display device 1A, the light source 20 may also be disposed on the side surface 11b, and light may be incident on the light guide plate 10A from the side surface 11b.

The light guide plate 10A also has an emission surface 11c. The emission surface 11c is a surface from which the light guided within the light guide plate 10A is emitted from the light guide plate 10A. The emission surface 11c is a main surface of the light guide plate 10A having a rectangular parallelepiped shape.

The light guide plate 10A also has a plurality of light deflectors 12. The light deflector 12 deflects the light that is incident on the incident surface 11a and guided in the light guide plate 10A, causing the light to be emitted from the emission surface 11c. The light deflectors 12 in this embodiment have a V-groove structure extending in a direction according to the position of the observation space with respect to the light guide plate 10A and the display position of the stereoscopic image SI, and are formed in a plurality of rows aligned in the incident direction. For ease of description, the number of the light deflectors 12 formed on the light guide plate 10A is shown in the drawings to be smaller than the actual number.

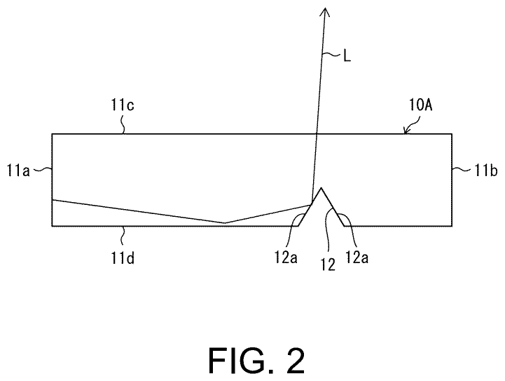

FIG. 2 is a cross-sectional view showing the path of light guided by the light guide plate 10A. As shown in FIG. 2, the light deflector 12 is provided on a rear surface 11d of the light guide plate. The rear surface lid is the other main surface of the light guide plate 10A having a rectangular parallelepiped shape, facing the emission surface 11c.

The light deflector 12 has an inclined surface 12a (light deflection surface) that reflects the light from the light source 20 that is incident on the incident surface 11a toward the emission surface 11c. In this embodiment, in order to reflect light L incident from the incident surface 11a, the light deflector 12 has an inclined surface 12a corresponding to the incident surface 11a. In the case where light is also incident from the side surface 11b, the light guide plate 10A further includes the light deflector 12 having an inclined surface 12a corresponding to the side surface 11b. In addition to the inclined surface 12a, the light deflector 12 may further have a surface for reflecting light that is incident on the light deflector 12 from a direction other than the intended direction in a direction that cannot be recognized by an observer.

In the light guide plate 10A, the light L incident from the incident surface 11a is guided while being totally reflected between the emission surface 11c and the rear surface 11d. The light L incident on the light deflector 12 is reflected by the inclined surface 12a and is incident on the emission surface 11c at an angle of incidence smaller than the angle of incidence at which the light L is totally reflected on the emission surface 11c. As a result, the light L is emitted from the emission surface 11c. However, the deflection of light by the light deflector 12 is not limited to that by reflection, and may be, for example, that by refraction.

The size of the light deflector 12 in a direction perpendicular to the incident direction of the light from the light source 20 may be, for example, 30 μm to 300 μm. The angle of the inclined surface 12a with respect to the rear surface 11d may be, for example, 30° to 60°. The shape of the light deflector 12 in plan view from a direction perpendicular to the rear surface lid may be a quadrangular shape such as a rectangle, or may be a spindle shape. In particular, in the latter case, the formability of the light deflector 12 is improved compared to the former shape. However, the size and shape of the light deflector 12 are not limited thereto.

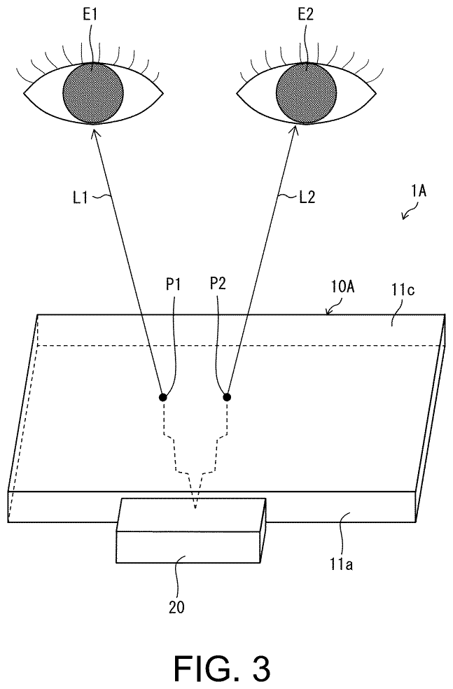

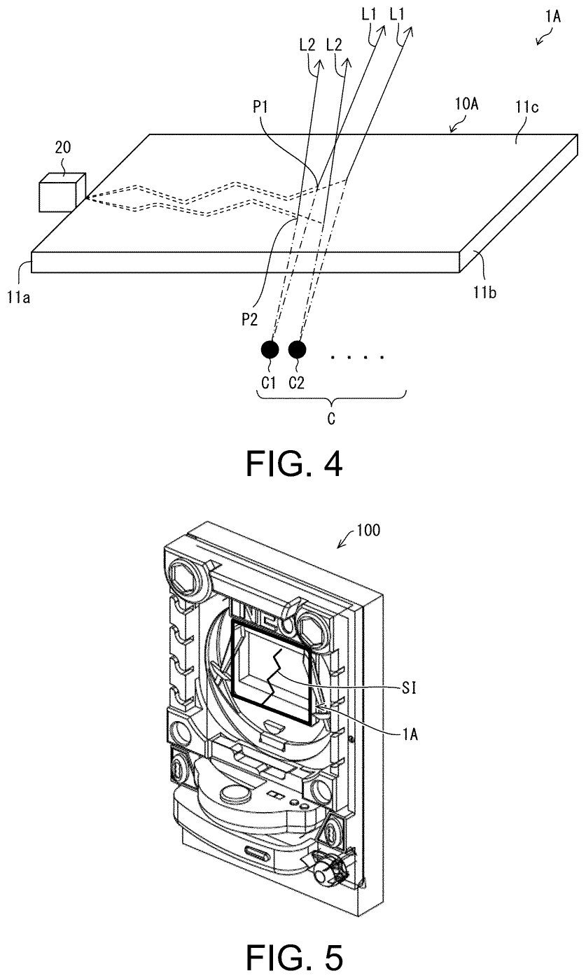

FIG. 3 is a perspective view for describing the directivity of emission light emitted from the emission surface 11c of the light guide plate 10A. FIG. 4 illustrates the principle of stereoscopic display based on parallax, and is a perspective view showing the intersection point where a straight line passing through a first emission point P1 and the center of one of the observer's eyes E1 intersects with a straight line passing through a second emission point P2 and the center of the other observer's eye E2. For simplicity, only one light source 20 is shown in FIGS. 3 and 4.

FIG. 3 shows a state in which an observer is observing the display device 1A from within an observation space of a predetermined range. The observation space is a space in which at least a part of the stereoscopic image SI displayed by the display device 1A are observable.

The light emitted within an angular range irradiated to one eye E1 and its vicinity of the observer is referred to as a first emission light L1, and the point on the emission surface 11c from which the first emission light L1 is emitted is referred to as the first emission point P1. The light emitted within an angular range irradiated to the other eye E2 and its vicinity of the observer is referred to as a second emission light L2, and the point on the emission surface 11c from which the second emission light L2 is emitted is referred to as the second emission point P2.

The first emission light L1 emitted from the first emission point P1 is viewed by the one eye E1 of the observer. On the other hand, the first emission light L1 is not seen by the other eye E2, or the light amount seen by the other eye E2 is very small compared to the light amount seen by the one eye E1. As a result, the first emission light L1 has directivity.

Moreover, the second emission light L2 from the second emission point P2 is viewed by the other eye E2 of the observer. On the other hand, the second emission light L2 is not seen by the one eye E1, or the light amount seen by the one eye E1 is very small compared to the light amount seen by the other eye E2. As a result, the second emission light L2 has directivity.

As shown in FIG. 4, a straight line passing through the first emission point P1 and the center of the one eye E1, i.e. the pupil and the crystalline lens, intersects at an intersection point C with a straight line passing through the second emission point P2 and the center of the other eye E2. In other words, the optical axis of the first emission light L1 viewed by the one eye E1 of the observer and the optical axis of the second emission light L2 viewed by the other eye E2 of the observer intersect at the intersection point C. Thus, the observer has the illusion that there is a light-emitting point at the intersection point C.

When the intersection point C is located on the observer side with respect to the emission surface 11c, the observer sees the light-emitting point projecting from the emission surface 11c. On the other hand, when the intersection point C is located on the opposite side of the emission surface 11c to the observer, the light-emitting point appears to be located further inside than the emission surface 11c to the observer. In this embodiment, the intersection point C is located on the inner side of the emission surface 11c as viewed by the observer. This causes the observer to perceive a sense of depth.

In this way, in the case where the first emission light L1 is emitted within an angular range toward the one eye E1 and its vicinity of the observer, the second emission light L2 is emitted within an angular range toward the other eye E2 and its vicinity of the same observer, and the optical axis of the first emission light L1 and the optical axis of the second emission light L2 have an intersection point C, the observer will have the illusion that there is a light-emitting point at the intersection point C. Thus, by forming such an intersection point C as a collection of consecutive points to become a plurality of intersection points C1, C2, . . . , the observer is able to perceive a three-dimensional stereoscopic image SI that is, for example, a straight line.

The light source 20 is a light emitting element that causes light to be incident on the light guide plate 10A. The light source 20 may be a point light source. Examples of the light source 20 include a light emitting diode (LED) or a laser diode (LD). However, the light source 20 is not limited thereto, and may be another light source such as a fluorescent lamp. Moreover, in FIG. 1, the display device 1A includes one light source 20. However, the display device 1A may include a plurality of light sources 20. The plurality of light sources 20 may be disposed at intervals of, for example, 10 mm, but the intervals between the light sources 20 are not limited thereto.

As described above, the shape of the light guide plate 10A is not limited to the rectangular parallelepiped shape described above. For example, the light guide plate 10A may have a shape in such a way that the incident surface 11a is not flush, but stepped, with part of a region in a plan view seen from a direction perpendicular to the emission surface 11c cut out in a rectangular shape. In this case, the light sources 20 may be disposed along each of the non-flush incident surfaces 11a.

The controller 30 controls the turning on and off of the light source 20. When there are a plurality of light sources 20, the controller 30 may individually control their turning on and off.

In particular, when the plurality of light sources 20 are linearly arranged, the controller 30 may control the plurality of light sources 20 to turn on and off sequentially from one end of the linear arrangement to the other end. This allows rendition in which the stereoscopic image SI moves from one end of the linearly arranged light sources 20 to the other end.

Moreover, when a plurality of light sources 20 are linearly arranged, the controller 30 may control the plurality of light sources 20 to turn on and off sequentially from any point other than one end and the other end of the linear arrangement to both one end and the other end. For example, the controller 30 may control the plurality of light sources 20 to be turned on and off sequentially symmetrically from the center of the linear arrangement to one end and the other end. This allows rendition in which the stereoscopic image SI appears to split and move from the center to both ends of the linearly arranged light sources 20.

The light source 20 may also be a so-called Red Green Blue Light Emitting Diode (RGB LED), which is capable of adjusting the color of light. In this case, the controller 30 may control the color of the light emitted by the light source 20. The controller 30 is able to achieve an effective rendition by, for example, making the colors of light emitted by adjacent light sources 20 different from each other.

Furthermore, by overlaying a plurality of stereoscopic images of different colors, the controller 30 is able to achieve a more impactful rendition through color mixing. For example, by overlaying a stereoscopic image with (R, G, B)=(255, 0, 0) and a stereoscopic image with (R, G, B)=(0, 255, 255), the overlapping portion may be colored (R, G, B)=(255, 255, 255), i.e., white.

Furthermore, the controller 30 may overlay three or more stereoscopic images.

### Configuration Example

FIG. 5 is a perspective view showing a gaming machine 100 equipped with the display device 1A of the embodiment. As shown in FIG. 5, the gaming machine 100, such as a pachinko machine or a pachislot machine, is provided with the display device 1A. The display device 1A is disposed near the central portion of the gaming machine 100. The display device 1A displays images for various renditions, such as a rendition image indicating a jackpot or a rendition image indicating the expectation of a jackpot. Specifically, the display device 1A stereoscopically displays a stereoscopic image SI as an image display. The controller 30 is configured to perform controls such as control of whether or not to display the stereoscopic image SI, control of switching the light source 20 to be turned on at a predetermined timing, and control of switching between a plurality of light sources 20 that emit different colors at a predetermined timing.

The gaming machine 100 is merely one example of application of the display device 1A of the embodiment, and does not limit the application range of the display device 1A. The display device 1A of the embodiment may be applied to any object having a function of displaying an image. Another example of an application of the display device 1A is an in-vehicle displayer.

As shown in FIG. 1, in the display device 1A, the light deflectors 12 are disposed on arrangement lines 13. The arrangement lines 13 are linear arrangement regions provided on the light guide plate 10A. In FIG. 1, the arrangement lines 13 are a plurality of straight lines parallel to one another. However, the shape of the arrangement line 13 is not limited thereto. Other examples of the shape of the arrangement line 13 will be described later.

In the light guide plate 10A, the arrangement line 13 includes a multi-intersection arrangement line 131. In the multi-intersection arrangement line 131, the light deflectors 12 are provided such that the intersection point C is formed at multiple positions for each of the positions in the observation space of the above-mentioned one eye E1 and the other eye E2. As a result, in the light guide plate 10A, the portion of the stereoscopic image SI that is nearly parallel to the incident surface 11a can be clearly displayed, and transparency in the vicinity of the multi-intersection arrangement line 131 can be maintained.

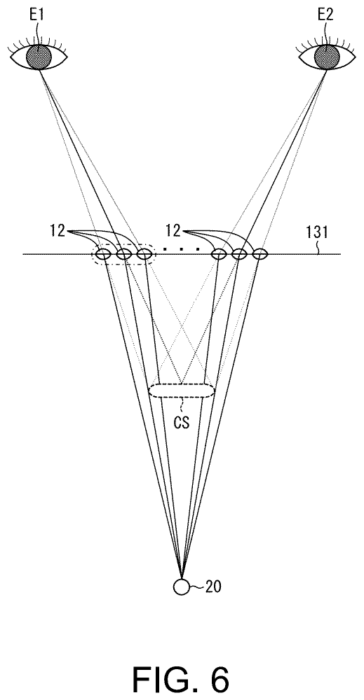

FIG. 6 is a diagram for describing the light deflected by the light deflector 12 on the multi-intersection arrangement line 131. As shown in FIG. 6, light from the light source 20 is deflected by the light deflector 12 on the multi-intersection arrangement line 131 and incident on the one eye E1 and the other eye E2 of an observer. Because the light deflector 12 forms the intersection point C at multiple positions for each of the positions within the observation space, the observer is given the illusion that a region CS as a collection of intersection points C formed at multiple positions rather than a single intersection point C, is the light-emitting region.

### (Arrangement of the Light Deflector)

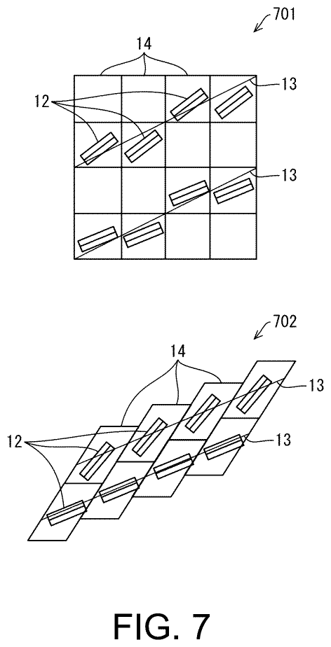

FIG. 7 is a diagram illustrating a specific example of the arrangement of the light deflector 12 in the light guide plate 10A. In FIG. 7, reference numeral 701 and reference numeral 702 denote different specific examples. In any of the specific examples, a matrix 14 is defined for the region in which the light deflector 12 is disposed, and the light deflector 12 is disposed within the matrix 14.

In the example indicated by the reference numeral 701, the matrix 14 is disposed along a direction parallel to the incident surface 11a and a direction perpendicular to the incident surface 11a. Moreover, the arrangement line 13 is inclined with respect to a direction parallel to the incident surface 11a. Thus, the arrangement line 13 is inclined with respect to the direction in which the matrix 14 is disposed. In this case, by disposing the light deflector 12 only in the matrix 14 located on the arrangement line 13, the light deflector 12 may be disposed along the multi-intersection arrangement line 131.

In the example indicated by the reference numeral 702, the matrix 14 is disposed in a direction along the arrangement line 13. In this case, by disposing the light deflector 12 in any matrix 14, the light deflector 12 may be disposed along the arrangement line 13.

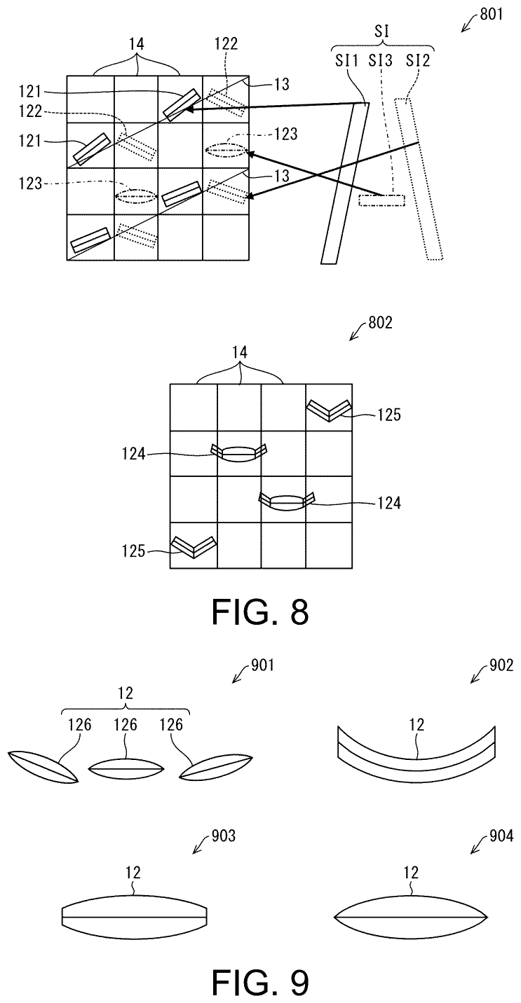

FIG. 8 is a diagram illustrating a more specific example of the arrangement of the light deflector 12 in the light guide plate 10A. In FIG. 8, reference numeral 801 and reference numeral 802 denote different examples. FIG. 8 shows an example in which an image of the letter “A” is displayed. In FIG. 8, a stereoscopic image SI, which is an image of the letter “A,” is divided into two stereoscopic images SI1 and SI2 of oblique lines and one stereoscopic image SI3 of horizontal line.

In the example indicated by the reference numeral 801, as the light deflector 12, there are shown a light deflector 121 for displaying a stereoscopic image SI1 of oblique line, a light deflector 122 for displaying a stereoscopic image SI2 of oblique line, and a light deflector 123 for displaying the stereoscopic image SI3 of horizontal line. The light deflector 121 and the light deflector 122 may be disposed in separate matrices 14 on the arrangement line 13. Moreover, the light deflector 123 may be disposed in parallel to the arrangement lines 13 in yet another matrix 14.

Moreover, the light deflector 12 may display two or more of the stereoscopic images SI1 and SI2 of oblique lines and the stereoscopic image SI3 of horizontal line. In the example indicated by the reference numeral 802, as the light deflector 12, there are shown a light deflector 124 for displaying the stereoscopic images SI1 and SI2 of oblique lines and the stereoscopic image SI3 of horizontal line, and a light deflector 125 for displaying the stereoscopic images SI1 and SI2 of oblique lines. The light deflector 124 and the light deflector 125 may be disposed in separate matrices 14 on the arrangement line 13.

When the shape of the light deflectors 12 is constant, the transparency of the light guide plate 10A may vary according to the density of the light deflectors 12. In order to reduce the variation, the shape of the light deflector 12 may be changed as appropriate. Alternatively, dummy light deflectors 12 that are not related to the display of the stereoscopic image SI may be disposed in a region where the density of the light deflectors 12 is low.

(Shape of the Light Deflector in which the Light Amount of Deflected Light is Substantially Uniform)

FIG. 9 is a diagram illustrating a specific example of the shape of the light deflector 12 disposed on the multi-intersection arrangement line 131. In FIG. 9, reference numerals 901 to 904 denote examples of different shapes of the light deflector 12. In particular, in the example indicated by the reference numeral 901, a collection of the plurality of partial light deflectors 126 constitutes one light deflector 12.

As shown in FIG. 9, in this configuration example, the inclined surface 12a of the light deflector 12 disposed on the multi-intersection arrangement line 131 is a curved surface. The curved surface continuously changes the direction in which the light L emitted from the light source 20 deflects from a first direction toward a first position in the observation space to a second direction toward a second position different from the first position. Thus, the observer is able to view the light deflected by the light deflector 12 from any position between the first position and the second position. In other words, at the same observation position, the observer can visually recognize the light deflector 12 that has the observation position as a first position to the light deflector 12 that has the observation position as a second position.

It is preferable that the light deflector 12 has a shape in which, when viewed in a plan view from a direction perpendicular to the rear surface lid, the length in the direction perpendicular to the incident surface 11a is shorter at the end portions than at the center in the direction parallel to the incident surface 11a. This improves the formability of the light deflector 12.

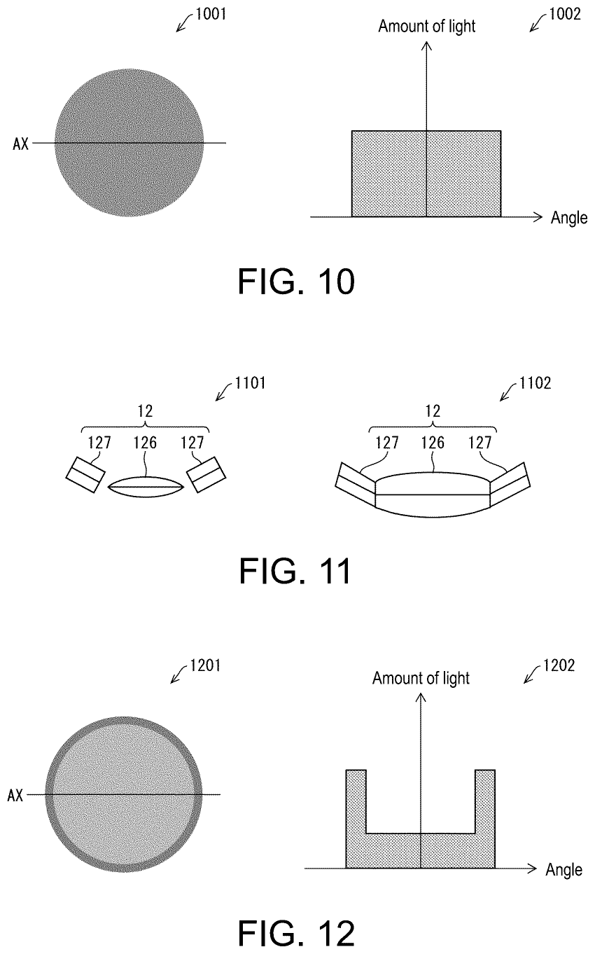

FIG. 10 is a diagram illustrating an example of a stereoscopic image displayed by the light deflector 12 shown in FIG. 9. In FIG. 10, the stereoscopic image displayed by the light deflector 12 is circular. Reference numeral 1001 denotes an example of a stereoscopic image that is actually displayed. Reference numeral 1002 denotes a graph showing the distribution of the light amount of the stereoscopic image indicated by the reference numeral 1001, deflected by the light deflector 12 that deflects the light onto an axis AX parallel to the incident surface 11a. In the reference numeral 1002, the horizontal axis represents the angle of the light deflected by the light deflector 12 with respect to the direction perpendicular to the rear surface lid, and the vertical axis represents the light amount.

As shown in FIG. 10, in a stereoscopic image displayed by the light deflector 12 shown in FIG. 9, the light amount may be considered to be approximately constant regardless of position. Specifically, the minimum value of light amount of light deflected by the light deflector 12 disposed on the multi-intersection arrangement line 131 in accordance with the direction in which the light is deflected is 0.7 times or more the maximum value of light amount.

Generally, in a stereoscopic image, if the minimum value of light amount is 0.7 times or more the maximum value of light amount, the observer will visually perceive the light amount as being approximately constant. Thus, such a light deflector 12 is capable of displaying a stereoscopic image parallel to the incident surface 11a, in which the light amount can be considered to be substantially constant. In particular, the minimum value of light amount may be 0.8 times or more the maximum value. In this case, the uniformity of the light amount in the stereoscopic image is further improved.

(Shape of the Light Deflector in which the Light Amount of Light Deflected at the End Portion is Greater than the Light Amount at the Center)

FIG. 11 is a diagram illustrating a specific example of the shape of the light deflector 12 other than that shown in FIG. 9. In FIG. 11, reference numerals 1101 and 1102 denote examples of different shapes of the light deflector 12. In the example indicated by the reference numerals 1101 and 1102 in FIG. 11, the light deflector 12 is a collection of a partial light deflector 126 in which the inclined surface 12a is a curved surface, and a partial light deflector 127 in which the inclined surfaces 12a is a flat surface, disposed on both sides of the partial light deflector 126. The partial light deflector 127 may be disposed apart from the partial light deflector 126 as indicated by the reference numeral 1101, or may be disposed in contact with the partial light deflector 126 as indicated by the reference numeral 1102.

FIG. 12 is a diagram illustrating an example of a stereoscopic image displayed by the light deflector 12 shown in FIG. 11. In FIG. 12, the stereoscopic image displayed by the light deflector 12 is circular. Reference numeral 1201 denotes an example of a stereoscopic image that is actually displayed. Reference numeral 1202 denotes a graph showing the distribution of the light amount of the stereoscopic image indicated by the reference numeral 1201, deflected by the light deflector 12 that deflects the light onto the axis AX parallel to the incident surface 11a. In the reference numeral 1202, the horizontal axis is the angle at which the light is deflected, and the vertical axis is the light amount.

In the light deflector 12 shown in FIG. 11, the area of the inclined surface 12a that deflects light in a first direction and the area of the inclined surface 12a that deflects light in a second direction are larger than the area of the inclined surface 12a that deflects light in the other direction. Thus, as shown in FIG. 12, in the stereoscopic image displayed by the light deflector 12 shown in FIG. 11, the light amount on the outer periphery is greater than the light amount on the inside. There is no particular restriction on the width of the outer periphery of the stereoscopic image, and it is sufficient that the light amount in a region including the end portion of the stereoscopic image is greater than the light amount in at least a part of the inside of that region.

By making the light amount greater on the outer periphery of a stereoscopic image than light amount on the inside, a stereoscopic image with clear contours may be displayed. Thus, even if the light amount inside the stereoscopic image is small, degradation in the quality of the entire stereoscopic image can be prevented.

Specifically, the average light amount of the light deflected by the light deflector 12 disposed on the multi-intersection arrangement line 131 in the outer peripheral region of the stereoscopic image twice or more the average light amount of light deflected by the light deflector 12 disposed on the multi-intersection arrangement line 131 in the region more toward the inside than the outer peripheral region of the stereoscopic image. Such a light deflector 12 is capable of displaying a stereoscopic image with particularly clear contours.

In the example shown in FIG. 12, the light deflected by the partial light deflector 126 constitutes the entire stereoscopic image. On the other hand, the light deflected by the partial light deflectors 127 constitute only the outer periphery of the stereoscopic image. That is, the outer periphery of the stereoscopic image is composed of light from both the partial light deflectors 126 and 127. On the other hand, the inside of the stereoscopic image is composed only of light from the partial light deflector 126. As a result, the light amount on the outer periphery of the stereoscopic image becomes greater than the light amount on the inside.

In the examples shown in FIGS. 9 and 11, the directivity of the light deflected by the light deflector 12 is symmetric in the direction along the multi-intersection arrangement line 131. However, the directivity of the light deflected by the light deflector 12 does not have to be symmetrical in the direction along the multi-intersection arrangement line 131.

### (Directivity of Light by the Light Deflector)

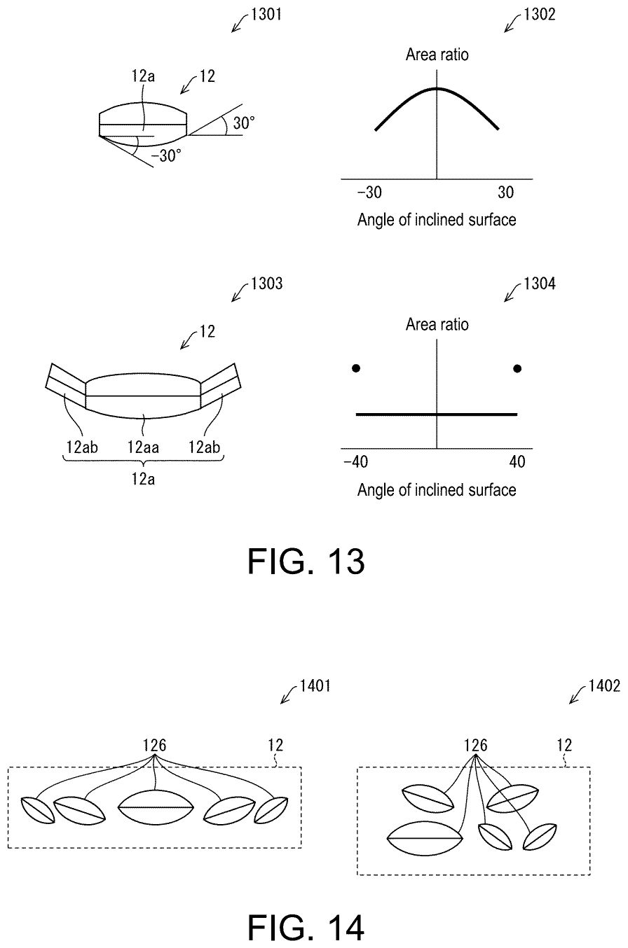

FIG. 13 is a diagram for describing the directivity of light by the light deflector 12. Reference numeral 1301 denotes a plan view illustrating an example of the shape of the light deflector 12. In the example indicated by the reference numeral 1301, in plan view from a direction perpendicular to the rear surface 11d, the angle formed between the inclined surface 12a of the light deflector 12 and a surface parallel to the incident surface 11a is in a range of −30° to 30°.

Reference numeral 1302 is a graph showing the relationship between the angle formed by the inclined surface 12a and a surface parallel to the incident surface 11a in the light deflector 12 having the shape shown in the reference numeral 1301, and the ratio (area ratio) of the area of the inclined surface 12a having the angle to the total area of the inclined surfaces 12a. In the reference numeral 1302, the horizontal axis represents the angle between the inclined surface 12a and a surface parallel to the incident surface 11a, and the vertical axis represents the area ratio.

For example, in the light deflector 12 having the shape indicated by the reference numeral 1301, the width of the inclined surface 12a in the light incident direction is 10 μm at the center in the direction perpendicular to the light incident direction and 5 μm at the end portion. In the graph indicated by the reference numeral 1302, when the area ratio at θ=0° is set to 1, the area ratio at θ=±30° is approximately 0.5. This is because the width of the inclined surface 12a in the incident direction of light, where θ=0°, at the end portion is half the width at the center in the direction perpendicular to the incident direction of light.

Reference numeral 1303 denotes an example of the shape of the light deflector 12 that is different from that of the reference numeral 1301. In the example indicated by reference numeral 1303, the inclined surface 12a has an inclined surface 12aa and an inclined surface 12ab located on both sides thereof. The inclined surface 12aa is a curved surface similar to the inclined surface 12a in the example indicated by the reference numeral 1301. The inclined surface 12ab is a flat surface having the same inclination as the end portion of the inclined surface 12aa. Thus, the inclined surface 12ab deflects light in the same direction that the light is deflected by the end portion of the inclined surface 12aa.

Reference numeral 1304 denotes a graph showing the relationship between the angle formed by the inclined surface 12a and a surface parallel to the incident surface 11a, and the area ratio of the inclined surface 12a having the angle in the light deflector 12 having the shape shown in the reference numeral 1303. In reference numeral 1304, the horizontal axis represents the angle between the inclined surface 12a and a surface parallel to the incident surface 11a, and the vertical axis represents the area ratio.

In the reference numeral 1304, the angle between the inclined surface 12a of the light deflector 12 and a surface parallel to the incident surface 11a is in a range of −40° to 40°. At the inclined surface 12ab, the angle formed by the inclined surface 12a and a surface parallel to the incident surface 11a is −40° or 40°. Thus, in the range of −40°<θ<40°, like the reference numeral 1302, the area ratio is largest at θ=0° and decreases as the angle moves away from θ=0°. On the other hand, the area ratios at θ=−40° and θ=40° are significantly larger than the area ratios at other angles. For this reason, in the reference numeral 1304, the variation in the area ratio is small in the range of −40°<θ<40°, and the graph is approximately flat.

For example, consider the light deflector 12 under the following conditions.
The material of the light guide plate 10A is polycarbonate with a refractive index of 1.59.
The angle of the inclined surface 12a with respect to the rear surface 11d is 50°.
In a plan view from a direction perpendicular to the rear surface 11d, the angle between the inclined surface 12a and a surface parallel to the incident surface 11a is in a range of −10° to 10°.
Within the range of angles over which the light is deflected by the light deflector 12, the light amount deflected is uniform.
At this time, the light deflected by the light deflector 12 is distributed in a range of −16° to 16°.
   (Light Deflector in which the Deflected Light Exhibits Gradation or Tone Expression)

FIG. 14 is a diagram illustrating a specific example of the shape of the light deflector 12 other than those shown in FIG. 10 and FIG. 12. In FIG. 14, reference numerals 1401 and 1402 denote examples of different shapes of the light deflector 12. In the examples indicated by the reference numerals 1401 and 1402 in FIG. 14, the light deflector 12 is a collection of a plurality of partial light deflectors 126. The size and shape of each partial light deflector 126 are not limited to those shown in FIG. 14, and may be determined appropriately.

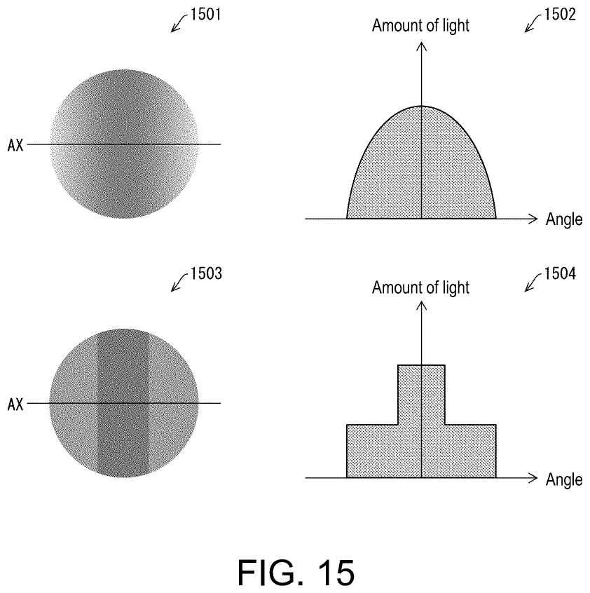

FIG. 15 is a diagram illustrating an example of a stereoscopic image displayed by the light deflector 12 shown in FIG. 14. In FIG. 15, the stereoscopic image displayed by the light deflector 12 is circular. Reference numeral 1501 denotes an example of a stereoscopic image that is actually displayed by the light deflector 12 indicated by the reference numeral 1401 in FIG. 14. Reference numeral 1502 denotes a graph showing the distribution of the light amount of the stereoscopic image indicated by the reference numeral 1501, deflected by the light deflector 12 that deflects the light onto the axis AX parallel to the incident surface 11a. Reference numeral 1503 denotes an example of a stereoscopic image actually displayed by the light deflector 12 indicated by the reference numeral 1402 in FIG. 14. Reference numeral 1504 denotes a graph showing the distribution of the light amount of the stereoscopic image indicated by the reference numeral 1503, deflected by the light deflector 12 that deflects the light onto the axis AX parallel to the incident surface 11a. In the reference numerals 1502 and 1504, the horizontal axis represents the angle at which the light is deflected, and the vertical axis represents the light amount.

As indicated by the reference numerals 1501 and 1502, the stereoscopic image displayed by the light deflector 12 indicated by the reference numeral 1401 in FIG. 14 exhibits a gradation in which the light amount gradually decreases from the center toward the outer periphery. This makes it possible to display a stereoscopic image with a faint glow at the end portions, like a neon sign.

As indicated by the reference numerals 1503 and 1504, in the stereoscopic image displayed by the light deflector 12 indicated by the reference numeral 1402 in FIG. 14, there is a region with a large light amount as another region in the central portion in the direction parallel to the incident surface 11a. That is, the stereoscopic image becomes a two-tone image. According to the size and shape of the partial light deflector 126 included in the light deflector 12, it is also possible to display stereoscopic images as indicated by the reference numerals 1503 and 1504.

(Light Deflector that is Resistant to Deformation)

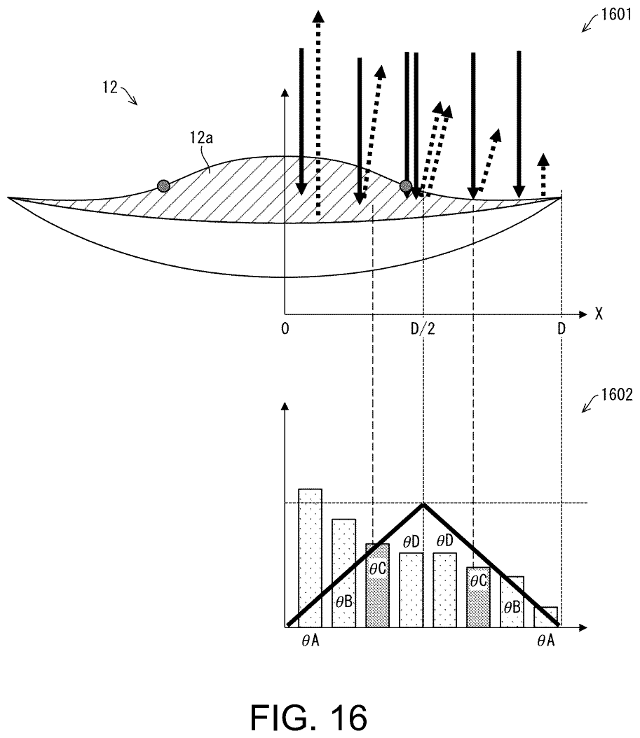

FIG. 16 is a diagram for describing still another example of the shape of the light deflector 12. In FIG. 16, reference numeral 1601 denotes a plan view of the light deflector 12 as viewed from a direction perpendicular to the rear surface 11d. In the reference numeral 1601, unlike FIG. 1 and the like, light is incident on the light deflector 12 from the upper side on the paper surface. In the reference numeral 1601, the light deflector 12 has a shape that is symmetrical with respect to an axis of symmetry perpendicular to the incident surface 11a. In the following, only one side of the light deflector 12 with respect to the axis of symmetry will be described.

The direction parallel to the incident surface 11a is the X direction, the axis of symmetry is X=0, and the distance in the X direction from the axis of symmetry of the light deflector 12 to the end portion is D. At X=0, the inclination of the inclined surface 12a is 0. In the range of 0 X<D/2, the inclination of the inclined surface 12a increases with increasing distance from the axis of symmetry. In the range of D/2≤X≤D, the inclination of the inclined surface 12a decreases with increasing distance from the axis of symmetry. At X=D, the inclination of the inclined surface 12a returns to 0. That is, the point X=D/2 on the inclined surface 12a is the inflection point of the inclination of the inclined surface 12a. At this time, the region of the inclined surface 12a where 0≤X≤D is point-symmetric with respect to the inflection point.

In FIG. 16, reference numeral 1602 denotes a graph showing the angle and light amount for each position of the light deflected by the light deflector 12 indicated by the reference numeral 1601. In the reference numeral 1602, the horizontal axis represents the position in the X direction, and the vertical axis represents the angle or light amount. In the reference numeral 1602, the line graph indicates the angle, and the bar graph indicates the light amount. The reference numeral 1602 denotes the points where the angle at which the light is deflected, θA, θB, θC, or θD.

As indicated by the reference numeral 1602, in the light deflector 12 indicated by the reference numeral 1601, for each of θA to θD, there are two locations one on each side of the inflection point where light is deflected at the same angle. For angles other than θA to θD, there are also two locations where the light is deflected at the same direction. The light amount of light deflected to a certain angle is the sum of the light amounts of light deflected at two locations of the light deflector 12. Moreover, since the width of the inclined surface 12a in the direction perpendicular to the X direction narrows as it moves away from X=0, the light amount deflected on the X=0 side with respect to the inflection point becomes greater than the light amount deflected on the X=D side. Thus, even if the shape of the end portion of the light deflector 12 is deformed in the vicinity of X=D due to a defect in the forming of the light deflector 12, the variation in the light amount is small. In other words, the inclined surface 12a may no longer be completely point-symmetric with respect to the inflection point due to the deformation of the end portion.

In the example shown in FIG. 16, the shape of the inclined surface 12a may be changed appropriately according to the stereoscopic image to be displayed. For example, by making the area of the inclined surface 12a constant for each angle, a stereoscopic image with uniform light amount as shown in FIG. 10 may be displayed. Moreover, by increasing the area of the inclined surface 12a at a particular angle, the light amount in the region of the stereoscopic image corresponding to that angle can be increased. For example, by widening the region near the inflection point of the inclined surface 12a, a stereoscopic image with enhanced contours as shown in FIG. 12 can be displayed.

In the example indicated by the reference numeral 1601, the inclination of the inclined surface 12a with respect to the incident surface 11a is small near X=0, increases as it approaches X=D/2, and decreases as it passes beyond X=D/2 and approaches X=D. That is, the inclination of the inclined surface 12a with respect to the incident surface 11a changes from small to large to small. However, the inclination of the inclined surface 12a with respect to the incident surface 11a may change conversely from large to small to large. Even in this case, there are two locations on both sides of the inflection point that deflect light in the same direction, so even if the shape of the light deflector 12 is deformed due to a forming defect in the vicinity of X=D, the variation in the light amount is small.

In this case, however, the inclination of the inclined surface 12a on the positive X side and the inclination of the inclined surface 12a on the negative X side are reversed at X=0. Thus, the inclined surface 12a has a protruding shape in the vicinity of X=0, and the shape of the inclined surface 12a is likely to be deformed.

### Modified Example 1

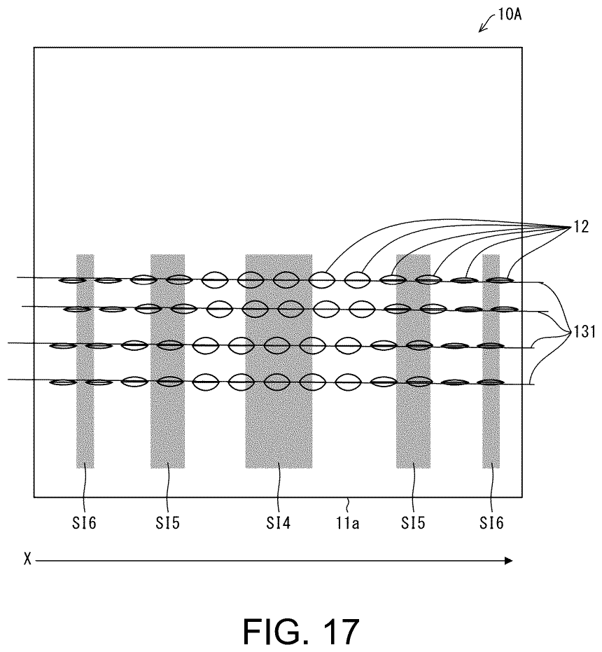

FIG. 17 is a diagram for describing the light deflector 12 according to a first modified example of the Embodiment 1. In the example shown in FIG. 17, the light guide plate 10A displays strip-shaped stereoscopic images SI4 to SI6 perpendicular to the incident surface 11a. The stereoscopic image SI4 is displayed by the light deflector 12 located near the center in the X direction on the light guide plate 10A. The stereoscopic image SI5 is displayed by each of the light deflectors 12 located on both sides of the light deflector 12 which displays the stereoscopic image SI4. The stereoscopic image SI6 is displayed by each of the light deflectors 12 located on the opposite side of the light deflectors 12 that displays the stereoscopic image SI5 from the light deflectors 12 that displays the stereoscopic image SI4.

The curvature of the light deflector 12 displaying the stereoscopic image SI5 is larger than the curvature of the light deflector 12 displaying the stereoscopic image SI6. Moreover, the curvature of the light deflector 12 displaying the stereoscopic image SI4 is further greater than the curvature of the light deflector 12 displaying the stereoscopic image SI5. The greater the curvature of the light deflector 12, the greater the range of angles over which the light deflector 12 deflects light. For example, for the light deflector 12 that displays the stereoscopic image SI6, the width of the angle at which light is deflected is set to 0°. Moreover, the light deflector 12 that displays the stereoscopic image SI4 has an angle width for deflecting light of 10°. Moreover, the light deflector 12 that displays the stereoscopic image SI5 has an angle range for deflecting light that is greater than 0° and less than 10°.

The greater the width of the angle at which the light deflector 12 deflects light, the greater the width in the X direction of the stereoscopic image displayed by the light deflector 12. Thus, among the stereoscopic images SI4 to SI6, the stereoscopic image SI4 has the widest width, the stereoscopic image SI6 has the narrowest width, and the stereoscopic image SI5 has a width between them. This creates a sense of perspective as if the stereoscopic image SI4 is positioned in the foreground, and the stereoscopic images SI5 and SI6 are positioned, in order, further away than the stereoscopic image S14.

### Modified Example 2

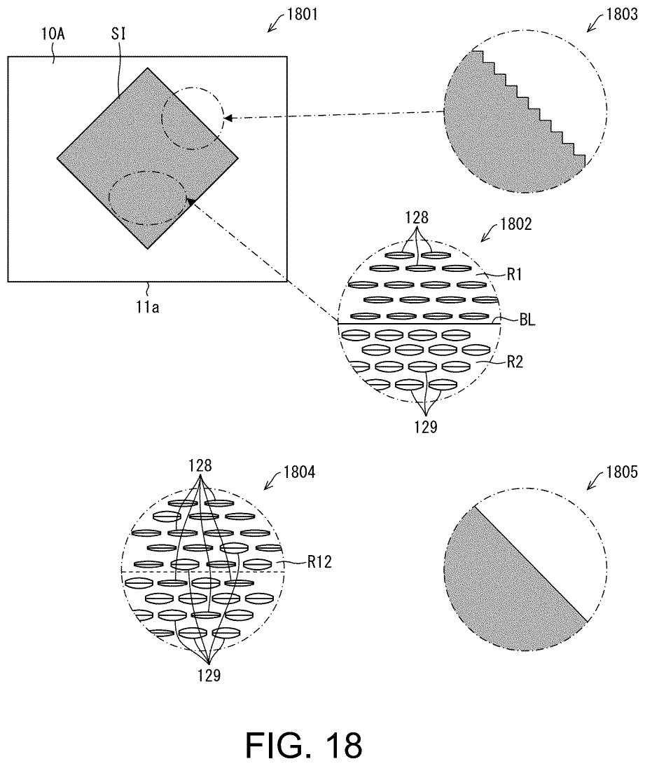

FIG. 18 is a diagram for describing the light deflector 12 according to a second modified example of the Embodiment 1. In FIG. 18, reference numeral 1801 denotes an overall view of the light guide plate 10A. In the example indicated by the reference numeral 1801, the stereoscopic image SI displayed by the light guide plate 10A is a rectangular image whose four sides are inclined with respect to the incident surface 11a. When displaying such a stereoscopic image SI, it is necessary to vary the curvature of the light deflector 12 in accordance with the width of the stereoscopic image SI in the direction along the multi-intersection arrangement line 131.

In the following description, the curvature of the light deflector 12 of a light guide plate 10A is defined by the width of the angle formed by the inclined surface 12a and the multi-intersection arrangement line 131. Specifically, the light deflector 12 in which the angle formed by the inclined surface 12a and the multi-intersection arrangement line 131 has a width of −n° to n° is defined as a light deflector 12 of θn. For example, the light deflector 12 in which the angle formed by the inclined surface 12a and the multi-intersection arrangement line 131 has a width of −1° to 1° is defined as an light deflector 12 with an angle of θ1.

Reference numeral 1802 denotes an enlarged view of a portion of the rear surface 11d of the light guide plate 10A in a comparative example. The reference numeral 1802 denotes a first light deflector 128 in which the curvature is a first curvature and a second light deflector 129 in which the curvature is a second curvature different from the first curvature. In the comparative example, a first light deflection region R1 in which the first light deflector 128 is disposed and a second light deflection region R2 in which the second light deflector 129 is disposed are in contact with each other at a boundary line BL.

Reference numeral 1803 is an enlarged view of an end portion of the stereoscopic image SI in the case where the first light deflector 128 and the second light deflector 129 are disposed as shown in the reference numeral 1802. When the first light deflector 128 and the second light deflector 129 are disposed as indicated by the reference numeral 1802, the light amount switches at the boundary line BL between the first light deflection region R1 and the second light deflection region R2, and thus a line corresponding to the boundary line BL may be visible to the observer. In particular, at the end portion of the stereoscopic image SI, as indicated by the reference numeral 1803, the boundary line BL between the first light deflection region R1 and the second light deflection region R2 may appear as a jagged shape.

Reference numeral 1804 denotes an enlarged view of a part of the rear surface 11d of the light guide plate 10A in this modified example. Specifically, the reference numeral 1804 is an enlarged view of a middle region R12 of the rear surface lid of the light guide plate 10A. The middle region R12 is a region provided between the first light deflection region R1 and the second light deflection region R2 indicated by the reference numeral 1802. In the middle region R12, the first light deflector 128 and the second light deflector 129 are disposed in a randomly mixed state.

Reference numeral 1805 denotes an enlarged view of an end portion of the stereoscopic image SI in a case where the middle region R12 is provided on the rear surface 11d of the light guide plate 10A. When the middle region R12 is provided on the rear surface lid of the light guide plate 10A, the boundary between the first light deflection region R1 and the second light deflection region R2 may be blurred. For this reason, the line corresponding to the boundary between the first light deflection region R1 and the second light deflection region R2 becomes less visible to the observer. For example, at the end portion of the stereoscopic image SI, as indicated by the reference numeral 1805, the jagged shape as seen in the comparative example are less likely to be visually recognized.

Furthermore, when the curvature of the light deflector 12 is constant, the width of the stereoscopic image SI displayed by the light deflector 12 in the direction along the multi-intersection arrangement line 131 becomes wider as the position of the light deflector 12 becomes farther away from the incident surface 11a. For this reason, even when a stereoscopic image having a constant width in the direction along the multi-intersection arrangement line 131 is displayed, the curvature of the light deflector 12 needs to be switched according to the distance from the incident surface 11a.

### Modified Example 3

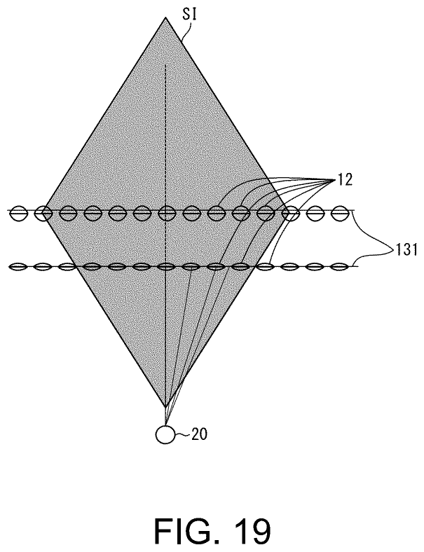

FIG. 19 is a diagram for describing the light deflector 12 according to a third modified example of the Embodiment 1. In FIG. 19, the stereoscopic image SI displayed by the light deflector 12 has a diamond shape with the shorter diagonal line parallel to the multi-intersection arrangement line 131.

In FIG. 19, assume that the light amount deflected by each of the light deflectors 12 is constant for each of the multi-intersection arrangement lines 131 on which the light deflectors 12 are disposed. When such a stereoscopic image SI is displayed under these conditions, if the shape and density of the light deflector 12 are constant, the light amount in a wide region in the direction along the multi-intersection arrangement line 131 will be smaller than the light amount in a narrow region. Thus, in order to reduce the variation in the light amount, it is necessary to change the shape and density of the light deflector 12.

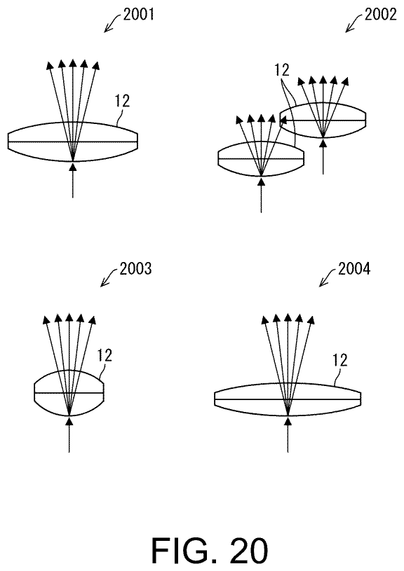

FIG. 20 is a diagram illustrating an example of the light deflector 12 in a region where the width of the stereoscopic image SI in the direction along the multi-intersection arrangement line 131 is wide. In FIG. 20, reference numerals 2001 to 2004 denote different examples of the light deflector 12.

In a region where the width of the stereoscopic image SI in the direction along the multi-intersection arrangement line 131 is wide, the light deflector 12 may simply be enlarged, for example, as indicated by the reference numeral 2001. In this case, the light deflector 12 in the region where the width of the stereoscopic image SI in the direction along the multi-intersection arrangement line 131 is wide and the light deflector 12 in the region where the width of the stereoscopic image SI in the direction along the multi-intersection arrangement line 131 is narrow are similar to each other.

Moreover, in a region where the width of the stereoscopic image SI in the direction along the multi-intersection arrangement line 131 is wide, the number of the light deflectors 12 may be increased, for example, as indicated by the reference numeral 2002. In this case, the shape of each light deflector 12 may be constant regardless of the width of the stereoscopic image SI in the direction along the multi-intersection arrangement line 131.

Moreover, in regions where the width of the stereoscopic image SI in the direction along the multi-intersection arrangement line 131 is wide, the width of the light deflector 12 may be widened either in the direction perpendicular to the multi-intersection arrangement line 131 or in the direction along the multi-intersection arrangement line 131, as indicated by the reference numerals 2003 and 2004, for example.

In regions where the width of the stereoscopic image SI in the direction along the multi-intersection arrangement line 131 is wide, the variation in the light amount deflected by the light deflector 12 can be reduced by changing the shape or number of the light deflector 12 as shown in FIG. 20. For example, if a middle value in the middle of the maximum value and the minimum value of light amount of light deflected in the reference direction by the light deflector 12, the minimum value is 0.7 times or more the middle value, and the maximum value is 1.3 times or less the middle value. The reference direction here means a direction in the middle between the first direction and the second direction. This makes it possible to reduce the variation in the light amount caused by the width of the stereoscopic image SI in the direction along the multi-intersection arrangement line 131 to a level that may be considered to be approximately constant.

In particular, the above-mentioned minimum value may be 0.8 times or more the middle value, and the maximum value may be 1.2 times or less the middle value.

When the size of the light deflector 12 is the same, for example, the light amount deflected in the reference direction by the light deflector 12 that deflects light in the range of −10° to 10° is set as approximately twice the light amount deflected in the reference direction by the light deflector 12 that deflects light in the range of −20° to 20°. By setting the size of the light deflector 12 that deflects light in the range of −20° to 200 to \sqrt{2} times the size of the light deflector 12 that deflects light in the range of −10° to 10°, the light amount deflected in the reference direction by these light deflectors 12 may be considered to be approximately constant.

### Embodiment 2

Other embodiments of the disclosure are described below. For ease of description, the same reference numerals will be used to refer to components having the same functions as those described in the above embodiment, and their descriptions will not be repeated.

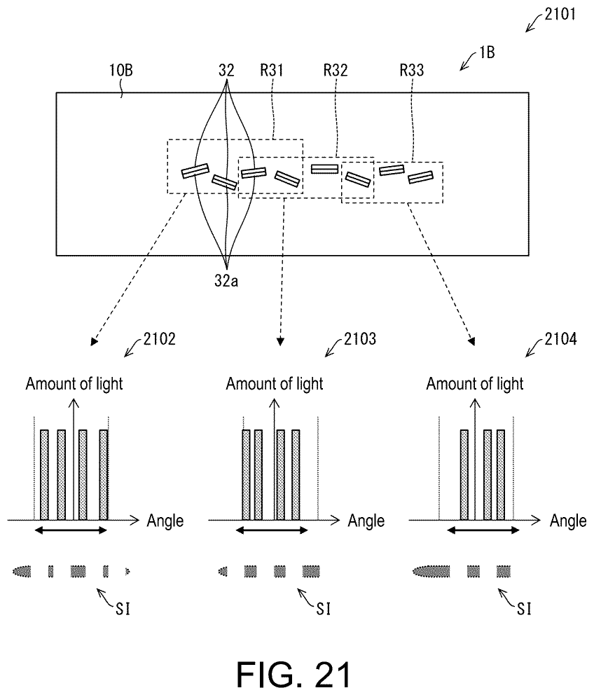

FIG. 21 is a diagram illustrating an example of a display device 1B according to the Embodiment 2. In FIG. 21, reference numeral 2101 denotes a plan view illustrating a main part of the display device 1B according to the Embodiment 2. Specifically, the reference numeral 2101 denotes a main portion of the light guide plate 10B included in the display device 1B. As indicated by the reference numeral 2101, the light guide plate 10B differs from the light guide plate 10A in that a plurality of light deflectors 32 is provided instead of the plurality of light deflectors 12. Each of the plurality of light deflectors 32 has an inclined surface 32a (light deflection surface) that deflects light. The directions in which the inclined surfaces 32a of the plurality of light deflectors 32 disposed on the multi-intersection arrangement line 131 deflect light are dispersed between a first direction toward a first position in the observation space and a second direction toward a second position different from the first position.

For example, consider a case where the first position exists in a direction of −n° with respect to a direction perpendicular to the rear surface lid, and the second position exists in a direction of +n° with respect to a direction perpendicular to the rear surface 11d. In this case, the directions in which the inclined surfaces 32a deflect the light are dispersed between −n° and +n°. That is, the direction in which the light is deflected by the inclined surfaces 32a of the adjacent light deflectors 32 changes intermittently.

Reference numerals 2102 to 2104 denote graphs showing examples of the display of a stereoscopic image SI by the light guide plate 10B, observed from different positions. In the reference numerals 2102 to 2104, the horizontal axis indicates the angle of the light deflected by the light deflector 32, and the vertical axis indicates the light amount.

In the reference numeral 2101, regions R31 to R33 are regions on the rear surface lid. In the light guide plate 10B, the light deflectors 32 that contribute to the display of the stereoscopic image SI differ according to the observation position. For example, the light deflector 32 disposed in the region R31 contributes to the display of the stereoscopic image SI indicated by the reference numeral 2102. Moreover, the light deflector 32 disposed in the region R32 contributes to the display of the stereoscopic image SI indicated by the reference numeral 2103, and the light deflector 32 disposed in the region R33 contributes to the display of the stereoscopic image SI indicated by the reference numeral 2104.

Thus, the angle at which the light is actually viewed in the stereoscopic image SI varies between the first direction and the second direction, depending on the observation position. Thus, rendition in which the stereoscopic image SI blinks as the observation position changes is possible.

Specifically, the directions in which the inclined surfaces 32a of the light deflector 32 deflect light may be randomly dispersed between the first direction and the second direction. This allows rendition in which the stereoscopic image SI blinks randomly as the observation position changes.

In the examples indicated by the reference numerals 2102 to 2104, at the angle at which the light is visible, the light amount visible is uniform. However, the light amount at an angle at which the light is visible may vary depending on the angle. For example, as shown in FIG. 21, the light amount may vary at which the light is viewed depending on the angle.

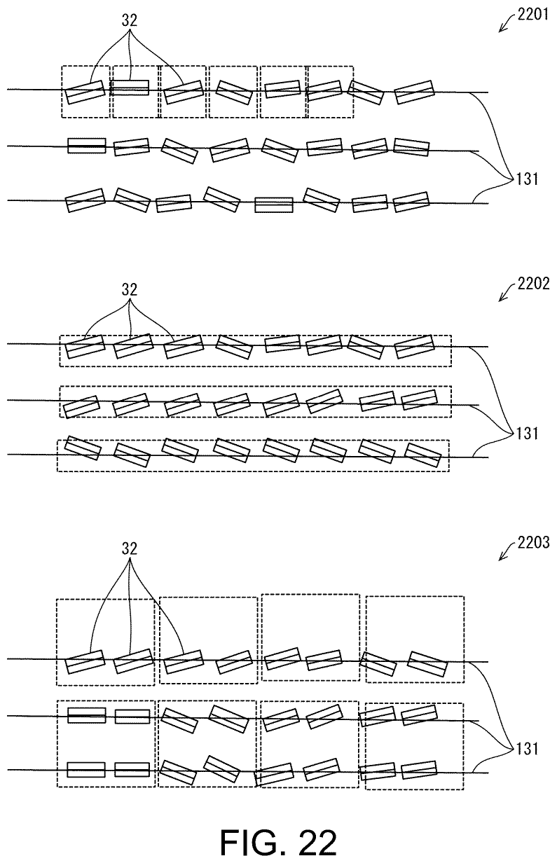

FIG. 22 is a diagram for describing the direction in which the light deflector 32 deflects light in the light guide plate 10B. In FIG. 22, reference numerals 2201 to 2203 denote different examples of the direction in which the light deflector 32 deflects light.

In the example indicated by the reference numeral 2201, the direction in which the light deflector 32 deflects the light differs for each individual light deflector 32. In this case, the stereoscopic image blinks in a granular manner, giving the observer the impression that the surface of the stereoscopic image has a so-called glittery texture.

In the example indicated by the reference numeral 2202, the direction in which the light deflectors 32 deflect light differs for each group of the light deflectors 32 linearly disposed. In this case, the stereoscopic image blinks linearly, giving the observer the impression of stainless steel-like depth lines.

In the example indicated by the reference numeral 2202, the direction in which the light deflectors 32 deflect light differs for each group of the light deflectors 32 disposed along the multi-intersection arrangement line 131. However, the direction in which the light deflectors 32 deflect light may also differ for each group of the light deflectors 32 disposed along a line in any direction different from the multi-intersection arrangement line 131. Moreover, in the example indicated by the reference numeral 2202, the direction in which the light deflector 32 deflects the light differs for each line. However, the direction in which the light deflector 32 deflects the light may also differ for each of the plurality of lines. Furthermore, the lengths of the lines on which the light deflectors 32 are disposed may also be different from each other.

In the example indicated by the reference numeral 2203, the direction in which the light deflectors 32 deflect light differs for each group of the light deflectors 32 disposed in a certain region. In this case, the stereoscopic image blinks in different regions, giving the observer the impression that there are so-called spangles placed on the surface of the stereoscopic image.

In the example indicated by the reference numeral 2203, the direction in which the light deflectors 32 deflect light differs for each group of two to four light deflectors 32 disposed in a rectangular region. However, the shape and size of the regions into which the light deflectors 32 are grouped are not limited to the example indicated by the reference numeral 2203. Furthermore, the shapes and sizes of the regions into which the light deflectors 32 are grouped may also differ at each position.

### Modified Example 1

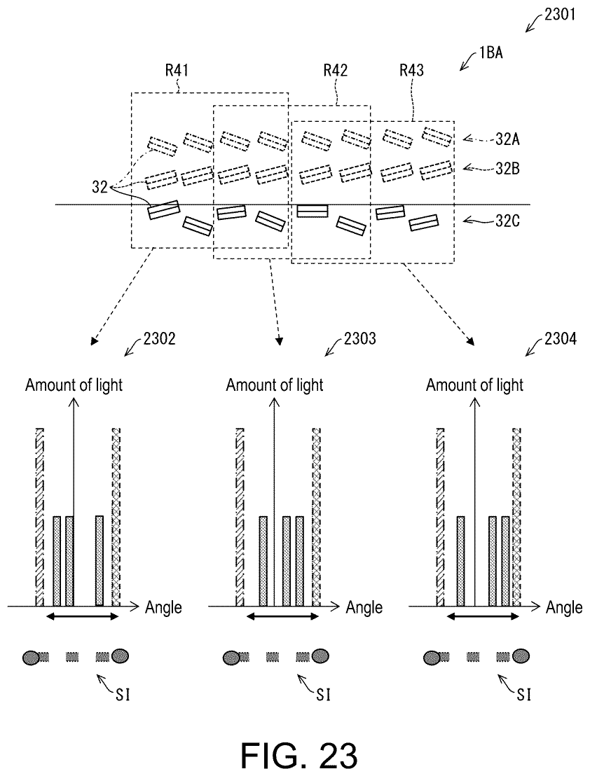

FIG. 23 is a diagram for describing a display device 1BA according to a first modified example of the Embodiment 2. In FIG. 23, reference numeral 2301 denotes a plan view illustrating a main part of the display device 1BA according to this modified example. In the display device 1BA according to this modified example, the light deflector 32 includes a first light deflector group 32A, a second light deflector group 32B, and a third light deflector group 32C.

The inclined surface 32a of the light deflector 32 included in the first light deflector group 32A is a surface whose direction of deflecting light is a first direction. The inclined surface 32a of the light deflector 32 included in the second light deflector group 32B is a surface whose direction of deflecting light is a second direction. The light deflectors 32 included in the third light deflector group 32C are surfaces whose direction of deflecting light changes intermittently between the first direction and the second direction. Furthermore, the light amount of light deflected by each of the light deflectors 32 included in the first light deflector group 32A and the second light deflector group 32B is greater than the light amount of light deflected by each of the light deflectors 32 included in the third light deflector group 32C.

Reference numerals 2302 to 2304 are graphs showing examples of the display of a stereoscopic image SI by the display device 1BA, observed from positions different from each other. In the reference numerals 2302 to 2304, the horizontal axis indicates the angle of the light deflected by the light deflector 32, and the vertical axis indicates the light amount.

In this modified example, the light deflector 32 disposed in a region R41 contributes to the display of the stereoscopic image SI indicated by the reference numeral 2302. Moreover, the light deflector 32 disposed in a region R42 contributes to the display of the stereoscopic image SI indicated by the reference numeral 2303, and the light deflector 32 disposed in a region R43 contributes to the display of the stereoscopic image SI indicated by the reference numeral 2304. Each of the regions R41 to R43 includes the light deflectors 32 of each of the first light deflector group 32A, the second light deflector group 32B, and the third light deflector group 32C.

For this reason, as indicated by the reference numerals 2302 to 2304, the regions at both ends of the stereoscopic image SI corresponding to the first direction and the second direction are displayed so as to have a greater light amount than the inner region, regardless of the viewing position. Since the inner region of the stereoscopic image SI may be or may not be displayed depending on the observation position, rendition in which the image blinks in response to changes in the observation position is possible.

Moreover, in FIG. 23, the light deflectors 32 of the first light deflector group 32A and the light deflectors 32 of the second light deflector group 32B are positioned apart from each other. However, the light deflectors 32 of the first light deflector group 32A and the light deflectors 32 of the second light deflector group 32B may be in contact with each other.

### Modified Example 2

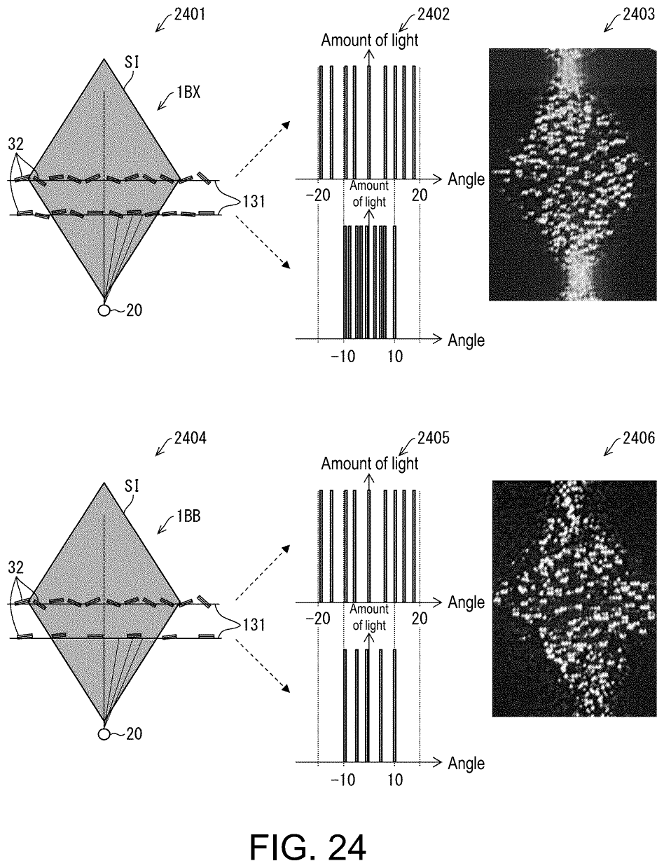

FIG. 24 is a diagram for describing a display device 1BB according to a second modified example of the Embodiment 2. In FIG. 24, reference numeral 2401 is a diagram illustrating an outline of a display on a display device 1BX according to a comparative example of this modified example. Reference numeral 2402 denotes a graph showing the relationship between the angle and the light amount displayed on the display device 1BX. Reference numeral 2403 denotes an image showing an example of an actual display by the display device 1BX. Reference numeral 2404 denotes an outline of a display on the display device 1BB according to this modified example. Reference numeral 2405 denotes a graph showing the relationship between the angle and the light amount displayed on the display device 1BB. Reference numeral 2406 denotes an image showing an example of an actual display by the display device 1BB.

In the display device 1BX, as indicated by the reference numeral 2401, the density of the light deflectors 32 on the multi-intersection arrangement line 131 is constant regardless of the width of the stereoscopic image SI corresponding to the multi-intersection arrangement line 131. The density of the light deflectors 32 here means the number of the light deflectors 32 per unit distance on the multi-intersection arrangement line 131. For this reason, as indicated by the reference numerals 2402 and 2403, the light amount is greater in a narrow region of the stereoscopic image SI than in a wide region of the stereoscopic image SI. Such a variation in the light amount for each position leads to a decrease in the quality of the stereoscopic image SI.

In the display device 1BB, as indicated by the reference numeral 2404, there is a positive correlation between the width of the stereoscopic image SI in a direction corresponding to the direction along the multi-intersection arrangement line 131 and the number of the light deflectors 32 disposed along the multi-intersection arrangement line 131. Specifically, on the multi-intersection arrangement line 131 where the width of the corresponding stereoscopic image SI is narrow, the light deflectors 32 are thinned out compared to on the multi-intersection arrangement line 131 where the width of the corresponding stereoscopic image SI is wide. Alternatively, more light deflectors 32 are disposed on the multi-intersection arrangement line 131 where the width of the corresponding stereoscopic image SI is wide than on the multi-intersection arrangement line 131 where the width of the corresponding stereoscopic image SI is narrow. This makes it possible to reduce the variation in the light amount caused by the width of the stereoscopic image SI, as indicated by the reference numerals 2405 and 2406.

### Embodiment 3

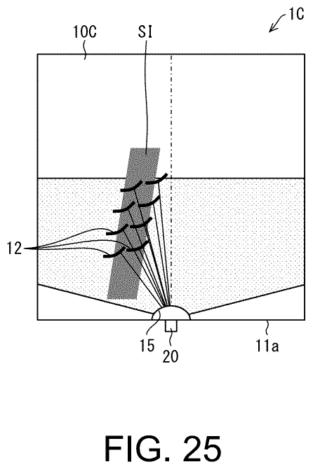

FIG. 25 is a plan view illustrating an example of a display device 1C according to the Embodiment 3. The display device 1C differs from the display device 1A in that a light guide plate 10C is provided instead of the light guide plate 10A. Alight entrance portion 15 is provided in the vicinity of the light source 20 on the incident surface 11a of the light guide plate 10C. The light entrance portion 15 is a portion where the incident surface 11a is formed into a concave shape.

In the light guide plate 10A that does not have the light entrance portion 15, the spread of light incident from the incident surface 11a is at most about 40° with respect to the optical axis, although this depends on the material of the light guide plate 10A. For this reason, it is difficult to display a stereoscopic image SI, which is large in size in the direction perpendicular to the optical axis, in the vicinity of the light source 20. For example, if the stereoscopic image SI has a size of 20 mm in a direction perpendicular to the optical axis, the position at which the light deflector 12 is disposed must be spaced 10 mm or more away from the light source 20 in the direction along the optical axis. However, the actual position at which the light deflector 12 is disposed is also influenced by conditions such as the shape of the stereoscopic image SI.

In the display device 1C, light from the light source 20 is incident on the light guide plate 10B through the light entrance portion 15. Thus, in the display device 1C, the spread of light incident from the light entrance portion 15 in a surface parallel to the main surface of the light guide plate 10C is greater than the spread of light incident on the light guide plate 10A from the flat incident surface 11a in the display device 1A. That is, in the light guide plate 10C, the region that light may reach in the vicinity of the incident surface 11a is wider than the region that light may reach in the vicinity of the incident surface 11a of the light guide plate 10A. This increases the degree of freedom in designing the light guide plate 10C.

The light entrance portion 15 may be a slit, a lens array, a diffusion member, or the like, disposed between the light source 20 and the incident surface 11a, in addition to the concave portion described above. An example of the diffusion member is frosted glass.

Furthermore, as in another embodiment described later, in the display device 1C as well, light may be made incident on the light guide plate 10C from another side surface adjacent to the incident surface 11a. In this case, however, there is a possibility that unintended light emission (crosstalk) may occur when light from the other side surface mentioned above is incident on the light deflector 12 located near the light entrance portion 15 and having a large inclination with respect to the incident surface 11a. Thus, the shape, size, etc. of the light deflector 12 located near the light entrance portion 15 may be appropriately adjusted so as to reduce crosstalk.

### Embodiment 4

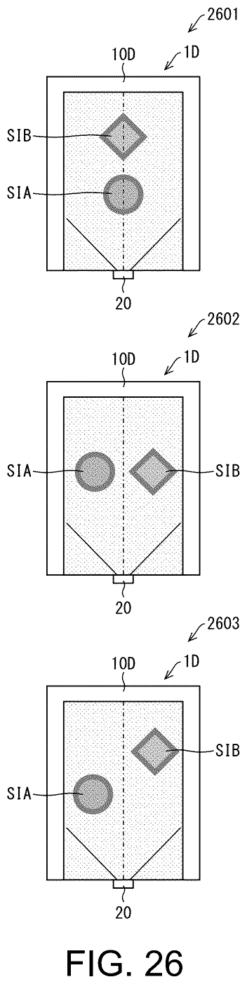

FIG. 26 is a plan view illustrating an example of a display device 1D according to the Embodiment 4. In FIG. 26, reference numerals 2601, 2602, and 2603 denote different examples of the display device 1D. In the example shown in FIG. 26, the display device 1D differs from the display device 1A in that a light guide plate 10D is provided instead of the light guide plate 10A. The light guide plate 10D may display a plurality of stereoscopic images SIA and SIB using light incident from the light source 20. In FIG. 26, the stereoscopic image SIA is a circular image, and the stereoscopic image SIB is a rectangular image of a character inclined with respect to the incident surface 11a. In FIG. 26, the display device 1D displays the stereoscopic images SIA and SIB using light from the same light source 20.

The stereoscopic images SIA and SIB may be adjacent to each other in the direction along the incident direction of light, as indicated by the reference numeral 2601. Furthermore, the stereoscopic images SIA and SIB may be adjacent to each other in a direction perpendicular to the incident direction of light, as indicated by the reference numeral 2602. Furthermore, the stereoscopic images SIA and SIB may be adjacent to each other in a direction different from both the incident direction of light and a direction perpendicular thereto, as indicated by the reference numeral 2603.

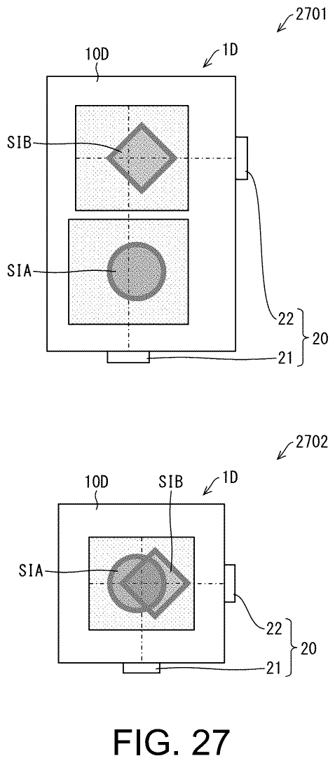

FIG. 27 is a plan view illustrating another example of the display device 1D. In FIG. 27, reference numerals 2701 and 2702 denote different examples of the display device 1D. In the example shown in FIG. 27, the display device 1D includes, as the light sources 20, a light source 21 that causes light to be incident from the incident surface 11a, and a light source 22 that causes light to be incident from another side surface lie adjacent to the incident surface 11a. In the display device 1D, the stereoscopic image SIA is displayed by light from the light source 21, and the stereoscopic image SIB is displayed by light from the light source 22.

The light deflector 12 for displaying the stereoscopic image SIA and the light deflector 12 for displaying the stereoscopic image SIB may be disposed in regions spaced apart from each other, as indicated by the reference numeral 2701. Furthermore, the light deflector 12 for displaying the stereoscopic image SIA and the light deflector 12 for displaying the stereoscopic image SIB may be disposed in the same region as each other, as indicated by the reference numeral 2702. In particular, in the example indicated by the reference numeral 2702, by switching whether the light source 21 or the light source 22 is turned on, it is possible to switch whether the display device 1D displays the stereoscopic image SIA or the stereoscopic image SIB.

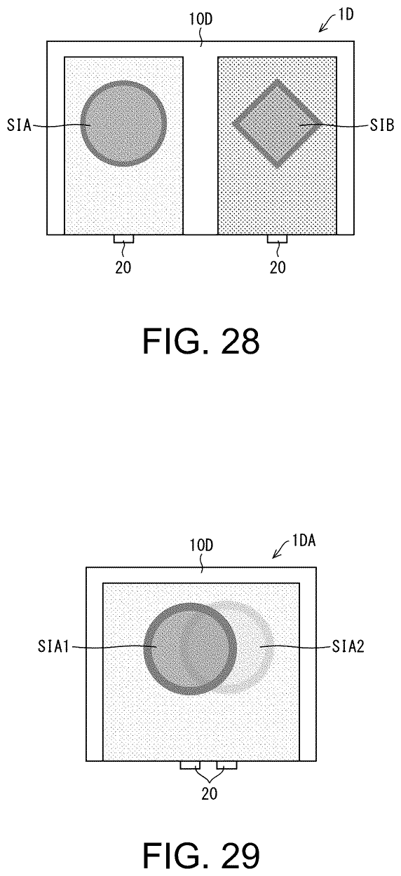

FIG. 28 is a plan view illustrating yet another example of the display device 1D. In the example shown in FIG. 28, the display device 1D displays the plurality of stereoscopic images SIA and SIB using light incident from the incident surface 11a of the light guide plate 10D. In the example shown in FIG. 28, the light source 20 for displaying the stereoscopic image SIA and the light source 20 for displaying the stereoscopic image SIB are separate from each other.

In the example shown in FIG. 28, the display device 1D has a structure that narrows the spread of light incident on the light guide plate 10D. For example, a convex lens (not shown) may be disposed between the light source 20 and the light guide plate 10D. Alternatively, the light source 20 may be a light source with high directivity, such as a cannonball LED. Alternatively, the incident surface 11a may have a shape that narrows the spread of the incident light. This reduces the possibility that, when the display device 1D displays only one of the stereoscopic images SIA and SIB, the other is unintentionally displayed.

Moreover, in the display device 1D, the stereoscopic images SIA and SIB are displayed by the light deflectors 12 in different partial regions of the light guide plate 10D. In other words, the stereoscopic image displayed by the display device 1D includes the stereoscopic image SIA (first stereoscopic image) displayed by the light deflector 12 in a first partial region, which is a part of the region of the light guide plate 10D, and the stereoscopic image SIB (second stereoscopic image) displayed by the light deflector 12 in a second partial region, which is a region other than the first partial region of the light guide plate 10D.

In such a display device 1D, the light deflector 12 may be provided such that the stereoscopic image SIA and the stereoscopic image SIB are observable from within the same observation space. In this case, the observer may view the first stereoscopic image SIA and the second stereoscopic image SIB from within the same observation space.

Furthermore, by making the observation space in which the first stereoscopic image SIA and the second stereoscopic image SIB are observable in a relatively narrow limited space, the first stereoscopic image SIA and the second stereoscopic image SIB may be displayed such that they are observable only from that limited space. On the other hand, by making the observation space in which the first stereoscopic image SIA and the second stereoscopic image SIB are observable in a relatively wide wide-region space, the first stereoscopic image SIA and the second stereoscopic image SIB may be displayed so as to be observable from a wide range. This wide-region space may include a position at an infinite distance from the light guide plate 10D.

Furthermore, in the display device 1D, the light deflector 12 may be provided such that an observation space in which the stereoscopic image SIA are observable and an observation space in which the stereoscopic image SIB are observable are disposed at different positions. In this case, when an observer views one of the stereoscopic image SIA and the stereoscopic image SIB, the reflection of the other may be reduced.

### Modified Example 1

FIG. 29 is a plan view illustrating a display device 1DA according to a first modified example of the Embodiment 4. In the example shown in FIG. 29, the distance between the light sources 20 is shorter than in the other examples. Moreover, the display device 1DA displays the plurality of stereoscopic images SIA1 and SIA2. The stereoscopic images SIA1 and SIA2 are circular images that may be considered to be identical to each other.

In this state, by appropriately adjusting the brightness of each of the light sources 20, rendition in which one of the plurality of stereoscopic images SIA1 and SIA2 appears to be a shadow of the other is possible. This allows the observer to feel a sense of front and rear.

### Modified Example 2

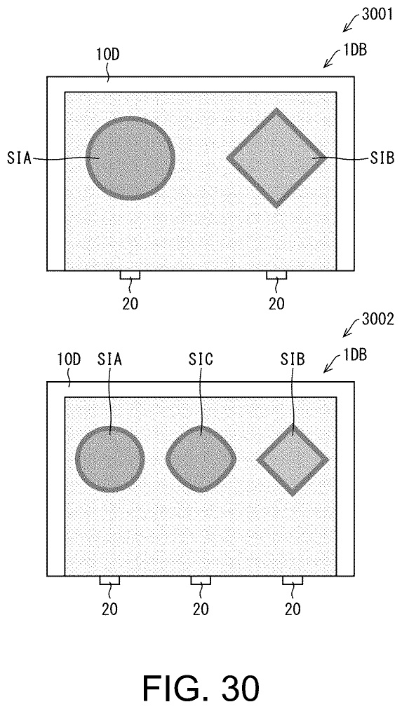

FIG. 30 is a plan view illustrating a display device 1DB according to a second modified example of the Embodiment 4. Reference numerals 3001 and 3002 in FIG. 30 denote different examples of the display device 1DB.

In the example indicated by the reference numeral 3001, for simplicity, a state in which all the light sources 20 are turned on simultaneously is shown. The display device 1DB performs a rendition called dissolve, in which the stereoscopic image SIA is switched to the stereoscopic image SIB while moving. Specifically, the light sources 20 that display the stereoscopic images SIA and SIB are controlled so as to switch from a state in which the display of the stereoscopic image SIA is dominant to a state in which the display of the stereoscopic image SIB is dominant. This allows impactful rendition in which the stereoscopic image SIA changes into the stereoscopic image SIB as it moves.

In the example indicated by the reference numeral 3002, the display device 1DB sequentially displays three types of stereoscopic images SIA, SIB, and SIC at different positions. Here, the stereoscopic image SIC is an image of a shape that is being obtained by transforming the stereoscopic image SIA into the stereoscopic image SIB, and is displayed at a position in the middle of the stereoscopic images SIA and SIB. For simplicity, the reference numeral 3002 denotes the stereoscopic images SIA, SIB, and SIC in a single drawing.

In the example indicated by the reference numeral 3002, the light source 20 is controlled such that the stereoscopic images SIA, SIC, and SIB are displayed in order. As a result, the display device 1DB performs a rendition called morphing, in which the stereoscopic image SIA moves and transforms into the stereoscopic images SIC and SIB in order.

### Modified Example 3

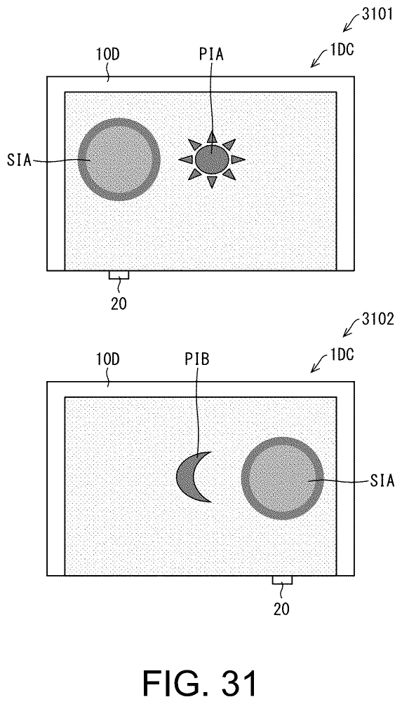

FIG. 31 is a plan view illustrating a display device 1DC according to a third modified example of the Embodiment 4. In the example shown in FIG. 31, the display device 1DC displays a stereoscopic image SIA and planar images PIA and PIB. In FIG. 31, reference numeral 3101 and reference numeral 3102 denote the display device 1DC in which the light sources 20 turned are different from each other. For simplicity, the light source 20 in the unlit state is omitted in FIG. 31.

As indicated by the reference numeral 3101 and the reference numeral 3102 in FIG. 31, the display position of the stereoscopic image SIA moves by switching the position of the light source 20 that is turned on. Moreover, when the stereoscopic image SIA is displayed at the position indicated by the reference numeral 3101, the planar image PIA is also displayed, and when the stereoscopic image SIA is displayed at the position indicated by the reference numeral 3102, the planar image PIB is also displayed. The planar images PIA and PIB are displayed at a fixed position on the emission surface 11c or the rear surface 11d of the light guide plate 10D. In the example of FIG. 31, the planar images PIA and PIB are switched according to the position of the light source 20 that is turned on. However, the same planar image may be displayed regardless of the position of the light source 20 that is turned on.

In this way, by combining the stereoscopic image SIA and the planar images PIA, PIB in the display device 1DC, a more impactful rendition is possible. Furthermore, when the observer refers to the planar images PIA and PIB displayed on the emission surface 11c or the rear surface 11d, the sense of depth of the stereoscopic image SIA displayed more on the inner side of the light guide plate 10D is further emphasized.

### Embodiment 5

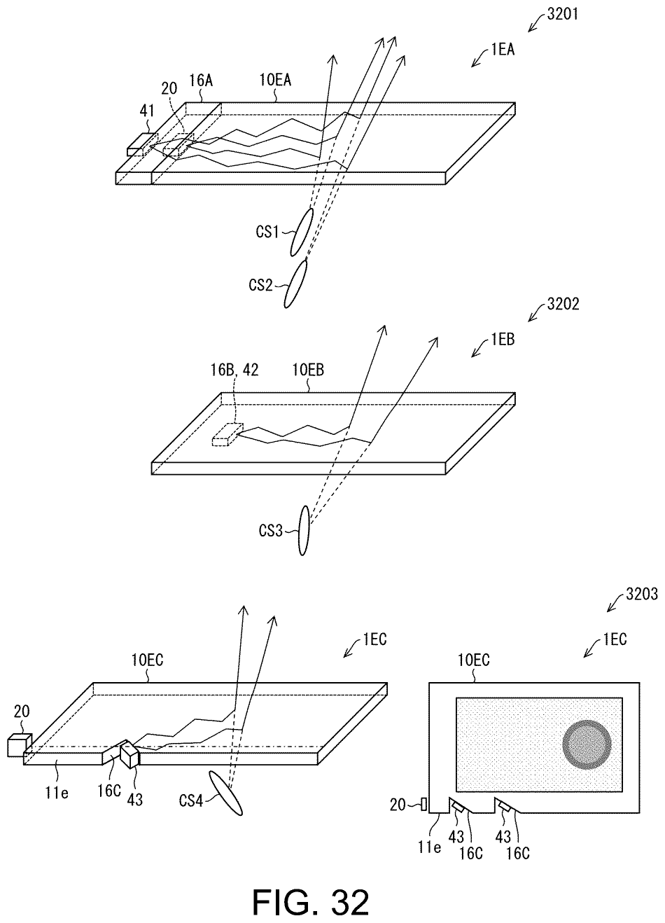

FIG. 32 is a diagram illustrating display devices 1EA, 1EB, and 1EC according to the Embodiment 5. In FIG. 32, reference numeral 3201 is a perspective view showing an outline of a display device 1EA, reference numeral 3202 is a perspective view showing an outline of a display device 1EB, and reference numeral 3203 is a perspective view and a plan view illustrating an outline of a display device 1EC.

As indicated by the reference numeral 3201, the display device 1EA includes a light guide plate 10EA instead of the light guide plate 10A, and an auxiliary light guide 16A. The light guide plate 10EA may have the same configuration as the light guide plate 10A. The auxiliary light guide 16A may have the same configuration as the light guide plate 10A, except that it does not have the light deflector 12.

The display device 1EA further includes a light source 41 which is a light source different from the light source 20. Light emitted from the light source 41 is incident on the light guide plate 10EA via the auxiliary light guide 16A and is emitted from the emission surface 11c. The distance that the light from the light source 41 travels until it is emitted from the emission surface 11c is longer by the length of the auxiliary light guide 16A than the distance that the light from the light source 20 travels until it is emitted from the emission surface 11c. For this reason, in the display device 1EA, a region CS1 that is a collection of intersection points for the light from the light source 20 and a region CS2 that is a collection of intersection points for the light from the light source 41 are generated. The depth amounts with respect to the light guide plate 10EA, that is, the distances as viewed from the light guide plate 10EA differ from each other in the region CS1 and the region CS2.

As indicated by the reference numeral 3202, the display device 1EB differs from the display device 1A in that a light guide plate 10EB is provided instead of the light guide plate 10A. The light guide plate 10EB differs from the light guide plate 10A in that it has a recess 16B. The recess 16B is a recess formed in the rear surface 11d of the light guide plate 10EB.

Moreover, the display device 1EB further includes a light source 42 which is a light source different from the light source 20. In the reference numeral 3202, the light source 20 is omitted. The light source 42 is housed in the recess 16B. The distance that light from the light source 42 travels until it is emitted from the emission surface 11c is shorter by the distance between the incident surface 11a and the recess 16B than the distance that light from the light source 20 travels until it is emitted from the emission surface 11c. For this reason, in the display device 1EB, the region CS1 (see the reference numeral 3201) that is a collection of intersection points for the light from the light source 20 and a region CS3 that is a collection of intersection points for the light from the light source 42 are generated. The depth amounts with respect to the light guide plate 10EB differ from each other in the region CS1 and the region CS3.

As indicated by the reference numeral 3203, the display device 1EC differs from the display device 1A in that a light guide plate 10EC is provided instead of the light guide plate 10A. The light guide plate 10EC differs from the light guide plate 10A in that a mid-way light entrance portion 16C is formed. The mid-way light entrance portion 16C is a portion provided on the side surface 11e of the light guide plate 10EC adjacent to the incident surface 11a, and allows light to be incident on the light guide plate 10EC.

Moreover, the display device 1EC further includes a light source 43 which is a light source different from the light source 20. The light source 43 causes light to be incident on the light guide plate 10EC from the mid-way light entrance portion 16C. Furthermore, the light source 20 in the display device 1EC is disposed near the side surface 11e such that the optical axis of the light from the light source 20 passes through the light source 43. The distance that light from the light source 43 travels until it is emitted from the emission surface 11c is shorter by the distance between the incident surface 11a and the mid-way light entrance portion 16C than the distance that light from the light source 20 travels until it is emitted from the emission surface 11c. For this reason, in the display device 1EC, the region CS1 (see the reference numeral 3201) that is a collection of intersection points for the light from the light source 20 and a region CS4 that is a collection of intersection points for the light from the light source 43 are generated. The depth amounts with respect to the light guide plate 10EC differ from each other in the region CS1 and the region CS4.

As described above, in each of the display devices 1EA, 1EB, and 1EC, a plurality of intersection points having different depth amounts from each other are generated for each arrangement line 13. Thus, each of the display devices 1EA, 1EB, and 1EC is able to display a plurality of stereoscopic images having different depth amounts from each other as a whole.

### Modified Example

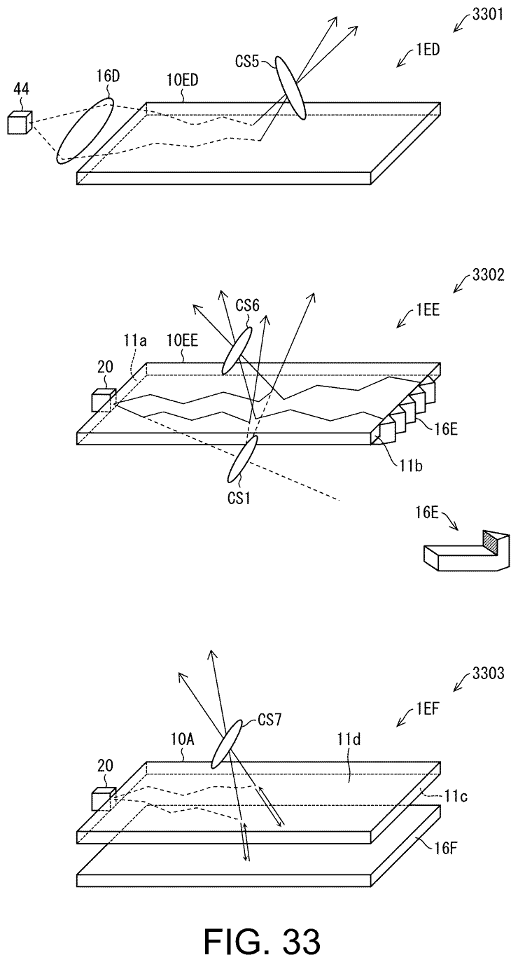

FIG. 33 is a diagram illustrating display devices 1ED, 1EE, and 1EF according to a modified example of the Embodiment 5. In FIG. 33, reference numeral 3301 is a perspective view showing an outline of the display device 1ED, reference numeral 3302 is a perspective view showing an outline of a display device 1EE, and reference numeral 3303 is a perspective view showing an outline of a display device 1EF.

As indicated by the reference numeral 3301, the display device 1ED includes a light guide plate 10ED, a lens 16D, and a light source 44. The light guide plate 10ED may have the same configuration as the light guide plate 10A. The light source 44 causes light to be incident on the light guide plate 10ED via the lens 16D. The display device 1ED also includes the light source 20, although not shown in the reference numeral 3301. In such a display device 1ED, the region CS1 (see the reference numeral 3201) of a collection of intersection points for the light from the light source 20 and a region CS5 of a collection of intersection points for the light from the light source 44 are generated.

The depth amounts with respect to the light guide plate 10ED differ from each other in the region CS1 and the region CS5. According to the characteristics of the lens 16D, the region CS5 may be generated on the observer side of the light guide plate 10ED, as indicated by the reference numeral 3301. Such a display device 1ED may also display a plurality of stereoscopic images having different depth amounts.

As indicated by the reference numeral 3302, the display device 1EE differs from the display device 1A in that a light guide plate 10EE is provided instead of the light guide plate 10A. The light guide plate 10EE differs from the light guide plate 10Ain that a retroreflective structure 16E is formed on the side surface 11b, which is the side surface opposite to the incident surface 11a.

The retroreflective structure 16E reflects light incident on the side surface 11b in a direction that may be considered to be substantially the same as the incident direction. However, instead of having the light guide plate 10EE, the display device 1EE may have a structure in which a separate retroreflective member having the same function as the retroreflective structure 16E is attached to the side surface 11b of the light guide plate 10A.

In the display device 1EE, a region CS6 of a collection of intersection points different from the region CS1 of the collection of intersection points is formed by the light reflected from the side surface 11b. According to the shape of the light deflector 12, the region CS6 may be located closer to the observer than the light guide plate 10EE, as indicated by the reference numeral 3302. Such a display device 1EE may also display a plurality of stereoscopic images having different depth amounts.

As indicated by the reference numeral 3303, the display device 1EF includes a retroreflector 16F in addition to the configuration of the display device 1A. The retroreflector 16F reflects incident light in a direction that may be considered to be substantially the same as the incident direction. The retroreflector 16F is disposed on the side of the emission surface 11c of the light guide plate 10A. For ease of visibility, the positional relationship between the emission surface 11c and the rear surface lid in the embodiment shown at the reference numeral 3303 is reversed from that in the other drawings.

In this modified example, an observer observes the display device 1EF from the rear surface 11d side. The light reflected by the retroreflector 16F forms a region CS7 of a collection of intersection points more on the observer side of the light guide plate 10A. Thus, according to the display device 1EF, by using the light guide plate 10A, a stereoscopic image may be displayed at a position closer to the observer than the light guide plate 10A. That is, the observer may view a stereoscopic image that appears to project forward from the light guide plate 10A.

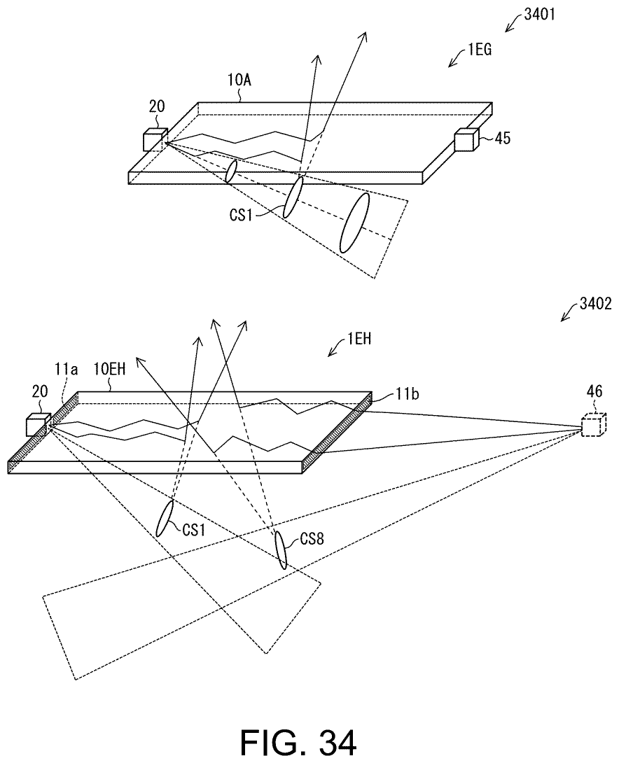

FIG. 34 is a diagram illustrating display devices 1EG and 1EH according to another modified example of the Embodiment 4, different from the one shown in FIG. 33. In FIG. 34, reference numeral 3401 is a perspective view showing an outline of the display device 1EG, and reference numeral 3402 is a perspective view showing an outline of a display device 1EH.

As indicated by the reference numeral 3401, the display device 1EG includes a light source 45 different from the light source 20 in addition to the configuration of the display device 1A. The light source 45 causes light to be incident on the light guide plate 10A from the side surface 11b opposite to the incident surface 11a. Such a display device 1EG also exhibits the same effects as the display device 1A and the like.

As indicated by the reference numeral 3402, the display device 1EH differs from the display device 1A in that a light guide plate 10EH is provided instead of the light guide plate 10A. The light guide plate 10EH differs from the light guide plate 10A in that the positions of the incident surface 11a other than the position where light from the light source 20 is incident, and the side surface 11b are reflective surfaces that reflect light.

In the display device 1EH, of the light incident on the light guide plate 10EH from the light source 20, the light incident on the side surface 11b is reflected and further guided within the light guide plate 10EH. The light reflected by the side surface 11b behaves as light from a virtual light source 46 located on the opposite side of the light source 20 with respect to the side surface 11b, and forms a region CS8 of the collection of intersection points different from the region CS1 of the collection of intersection points. Such a display device 1EH also exhibits the same effects as the display device 1A and the like.

### Embodiment 6

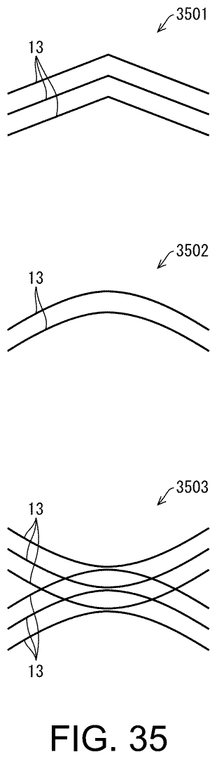

FIG. 35 is a plan view illustrating an example of the arrangement line 13 according to the Embodiment 6. In the above-described embodiment, the arrangement lines 13 are a plurality of straight lines parallel to one another, but the arrangement lines 13 are not limited thereto. The arrangement line 13 may be a straight line, a curved line, a combination of two or more straight lines, a combination of two or more curved lines, or a combination of one or more straight lines and one or more curved lines. Specific examples of such arrangement lines 13 are indicated by reference numerals 3501, 3502, and 3503 in FIG. 35.

In the display device 1A and the like, when the arrangement line 13 has such a shape, it is possible to express the stereoscopic image SI moving along the arrangement line 13 by switching the position of the light source 20 that is turned on or by moving the position in which the observer observes the stereoscopic image SI. This improves the freedom of expression of the stereoscopic image SI.

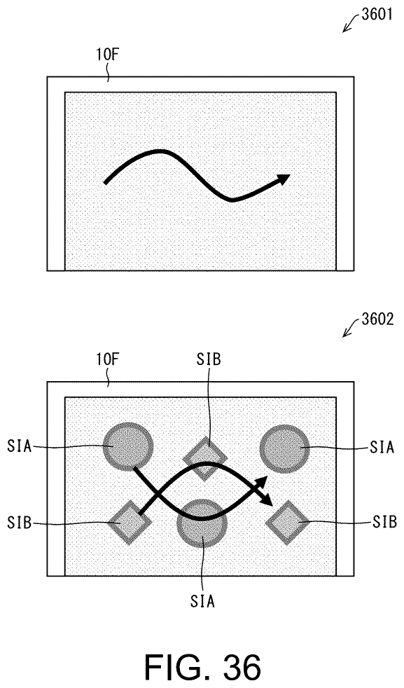

FIG. 36 is a plan view illustrating an example ofa light guide plate 10F according to the Embodiment 6. The light guide plate 10F differs from the light guide plate 10A in that it has arrangement lines 13 that are not linear. In FIG. 36, reference numerals 3601 and 3602 denote different examples of the light guide plate 10F. In FIG. 36, the arrangement lines 13 are illustrated as arrows indicating the movement direction of the stereoscopic image. Moreover, the reference numeral 3602 denotes, in a single drawing, the stereoscopic images SIA and SIB that appear at multiple positions during the movement.

In the light guide plate 10F indicated by the reference numeral 3601, the arrangement line 13 (see FIG. 35) is bent so as to follow the arrow in the drawing. Thus, the stereoscopic image displayed by the light guide plate 10F also moves along the arrow in the drawing. By reducing the width and period of the bends in the arrangement lines 13, rendition of the stereoscopic image in which it appears to move linearly in a direction parallel to the incident surface 11a is possible.

In the light guide plate 10F indicated by the reference numeral 3602, the arrangement line 13 on which the light deflectors 12 for displaying the stereoscopic image SIA are disposed has a curved shape that is convex in the direction approaching the incident surface 11a. On the other hand, the arrangement line 13 on which the light deflectors 12 for displaying the stereoscopic image SIB are disposed has a curved shape that is convex in a direction away from the incident surface 11a. The arrangement line 13 on which the light deflectors 12 for displaying the stereoscopic image SIA are disposed and the arrangement line 13 on which the light deflectors 12 for displaying the stereoscopic image SIB are disposed intersect with each other. In this light guide plate 10F, the stereoscopic images SIA and SIB temporarily switch positions in a direction perpendicular to the incident surface 11a while moving in a direction along the incident surface 11a, as indicated by the reference numeral 3602.

### Embodiment 7

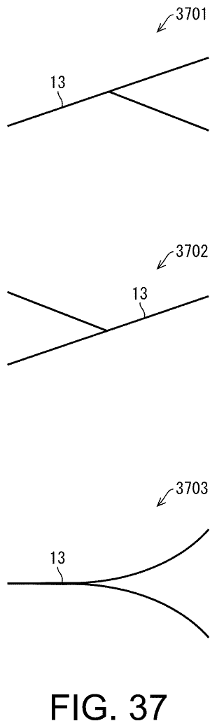

FIG. 37 is a plan view illustrating an example of the arrangement line 13 according to the Embodiment 7. In the above-described embodiment, the start point and the end point of each of the arrangement lines 13 are a single line, but the arrangement lines 13 are not limited thereto. The arrangement line 13 may include branching points or merging points of a plurality of lines. Specific examples of such arrangement lines 13 are indicated by reference numerals 3701, 3702, and 3703 in FIG. 37.

In the display device 1A and the like, when the arrangement line 13 has such a shape, by switching the position of the light source 20 that is turned on or by moving the position in which the observer views the stereoscopic image, expression of the stereoscopic image in which it appears to split or merge along the arrangement line 13. This increases the freedom of expression of stereoscopic images.

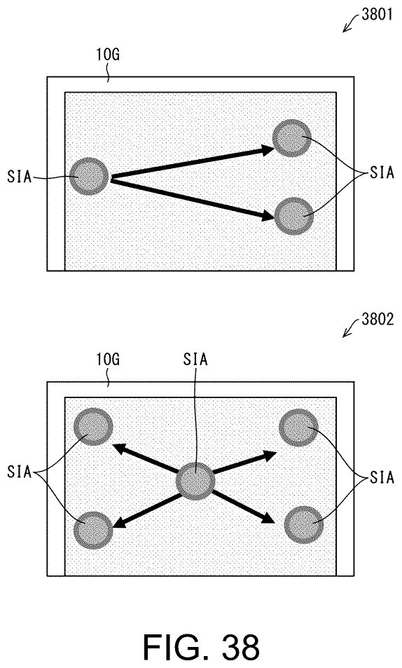

FIG. 38 is a plan view illustrating an example of a light guide plate 10G according to the Embodiment 7. The light guide plate 10G differs from the light guide plate 10A in that the arrangement lines 13 include branching points or merging points of a plurality of lines. In FIG. 38, reference numerals 3801 and 3802 denote different examples of the light guide plate 10G. In FIG. 38, the stereoscopic images SIA appearing at multiple positions during the course of movement are shown in a single drawing. Moreover, in FIG. 38, the arrangement lines 13 are illustrated as arrows indicating the movement direction of the stereoscopic image SIA.

In the light guide plate 10G indicated by the reference numeral 3801 in FIG. 38, the arrangement lines 13 have a shape branching in two directions from one end. In this case, the stereoscopic image SIA is a single image at the starting point of the movement, but is split into two and moves.

Moreover, in the light guide plate 10G indicated by the reference numeral 3802 in FIG. 38, the arrangement lines 13 have a shape branching out in four directions from one point. In this case, the stereoscopic image SIA is a single image at the starting point of the movement, but is split into four and moves.

In all of the examples shown in FIG. 38, the stereoscopic image SIA is split into a plurality of images. However, as described above, according to the arrangement line 13 of the Embodiment 7, a plurality of stereoscopic images may also be merged. For example, in the example shown in FIG. 38, by reversing the start point and the end position of the movement, two or four stereoscopic images SIA may be merged.

### Embodiment 8

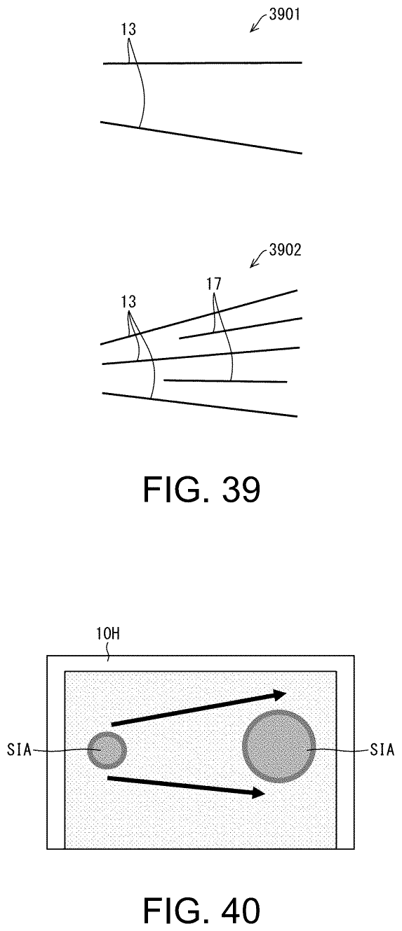

FIG. 39 is a plan view illustrating an example of the arrangement line 13 according to the Embodiment 8. In FIG. 39, reference numerals 3901 and 3902 denote different examples of the arrangement line 13 according to the Embodiment 8.

For example, as indicated by the reference numeral 3901 in FIG. 39, the arrangement lines 13 may include linear regions that are not parallel to each other. In the display device 1A and the like, when the arrangement line 13 has such a shape, it is possible to express the stereoscopic image as expanding or contracting along the arrangement line 13 by switching the position of the light source 20 that is turned on or by moving the position from which the observer views the stereoscopic image. This improves the freedom of expression of the stereoscopic image SI.

Furthermore, if there is a region where the interval between the arrangement lines 13 becomes excessively wide due to the arrangement lines 13 not being parallel to each other, an auxiliary arrangement line 17 may be added to that region, as indicated by the reference numeral 3902 in FIG. 39, for example. In this case, it is possible to suppress degradation of the image quality of the stereoscopic image while maintaining the freedom of expression of the stereoscopic image.

FIG. 40 is a plan view illustrating an example ofa light guide plate 10H according to the Embodiment 8. The light guide plate 10H differs from the light guide plate 10A in that the arrangement lines 13 are not parallel to each other. In FIG. 40, the stereoscopic images SIA appearing at multiple positions during the movement are shown in a single drawing. Moreover, in FIG. 40, the arrangement lines 13 are illustrated as arrows indicating the movement direction of the stereoscopic image SIA.

In the light guide plate 10H shown in FIG. 40, the intervals between the plurality of arrangement lines 13 increase as the stereoscopic image SIA moves from the start point to the end point. In this case, the stereoscopic image SIA is expanded as it moves along the arrangement line 13. Furthermore, in the light guide plate 10H, contrary to the example of FIG. 40, the intervals between the plurality of arrangement lines 13 may become narrower as the stereoscopic image SIA moves from the start point to the end point. In this case, the stereoscopic image SIA is reduced as it moves along the arrangement line 13.

The disclosure is not limited to the above-described embodiments, and various modifications are possible within the scope of the claims. Embodiments obtained by appropriately combining the technical means disclosed in different embodiments are also included in the technical scope of the disclosure.

### SUMMARY

The disclosure is also expressed as follows.

The light guide plate according to aspect 1 of the disclosure is a light guide plate for displaying a stereoscopic image based on parallax. The light guide plate includes:
an incident surface on which light from a light source is incident, an emission surface from which the light is emitted; and a plurality of light deflectors that deflect the light that is incident from the incident surface and guided and cause it to be emitted from the emission surface. The plurality of light deflectors are disposed on an arrangement line, which is a linear arrangement region. When a point on the emission surface from which a first emission light deflected by the light deflector is emitted into an angular range in which one eye and its vicinity of an observer observing the emission surface from within a predetermined range of observation space is irradiated is taken as a first emission point, and a point on the emission surface from which a second emission light deflected by the light deflector is emitted into an angular range in which to the other eye and its vicinity of the observer is irradiated is taken a second emission point, the plurality of the light deflectors disposed on the arrangement line are provided such that a straight line passing through the first emission point and a center of one eye and a straight line passing through the second emission point and a center of the other eye intersect with each other to form an intersection point. A plurality of the arrangement lines are provided, and at least one of the arrangement lines is a multi-intersection arrangement line in which the plurality of light deflectors are provided such that the intersection point is formed at multiple positions for each of the positions of the one eye and the other eye.

A light guide plate according to aspect 2 of the disclosure is such that, in aspect 1, each of the plurality of light deflectors has a light deflection surface that deflects the light, and the light deflection surface of the light deflector disposed on the multi-intersection arrangement line is a curved surface in which a direction in which the light emitted from one of the light sources is deflected changes continuously from a first direction toward a first position in the observation space to a second direction toward a second position different from the first position.

The light guide plate according to aspect 3 of the disclosure is such that, in aspect 2, a minimum value of light amount of light deflected by the light deflectors disposed on the multi-intersection arrangement line in accordance with a direction in which the light is deflected is 0.7 times or more a maximum value of light amount.

The light guide plate according to aspect 4 of the disclosure is such that, in aspect 2, an average light amount in an outer peripheral region of the stereoscopic image, of the light deflected by the light deflectors disposed on the multi-intersection arrangement line, is twice or more an average light amount in a region more inside of the stereoscopic image than the outer peripheral region, of the light deflected by the light deflectors disposed on the multi-intersection arrangement line.

The light guide plate according to aspect 5 of the disclosure is such that, in any one of aspects 2 to 4, the light deflector includes a first light deflector in which a curvature of the curved surface is a first curvature and a second light deflector in which the curvature is a second curvature different from the first curvature, and a middle region is provided between a first light deflection region in which the first light deflector is disposed and a second light deflection region in which the second light deflector is disposed, in which the first light deflector and the second light deflector are disposed in a randomly mixed state.

The light guide plate according to aspect 6 of the disclosure is such that, in any one of aspects 2 to 5, light amount of the light deflected by each of the plurality of light deflectors is constant for each of the multi-intersection arrangement lines on which the light deflectors are disposed, and when a middle value in the middle of a maximum value and a minimum value of the light amount deflected by the light deflectors in a reference direction which is a direction in the middle of the first direction and the second direction is taken as a middle value, the minimum value is 0.7 times or more the middle value, and the maximum value is 1.3 times or less the middle value.

The light guide plate according to aspect 7 of the disclosure is such that, in aspect 1, each of the light deflectors has a light deflection surface that deflects the light, and the directions in which the light deflection surfaces of the plurality of light deflectors disposed on the multi-intersection arrangement line deflect the light are dispersed between a first direction toward a first position in the observation space and a second direction toward a second position different from the first position.

The light guide plate according to aspect 8 of the disclosure is such that, in aspect 7, a direction in which the light deflection surfaces of each of the plurality of light deflectors deflects the light are randomly dispersed between the first direction and the second direction.

The light guide plate according to aspect 9 of the disclosure is such that, in aspect 7 or 8, the plurality of light deflectors include: a first light deflector group which is a collection of the light deflectors that deflect the light in the first direction with respect to the one eye and the other eye at any position; a second light deflector group which is a collection of the light deflectors that deflect the light in the second direction with respect to the one eye and the other eye at any position; and a third light deflector group which is a collection of the light deflectors that deflect the light in a random direction between the first direction and the second direction.

The light guide plate according to aspect 10 of the disclosure is such that, in any of aspects 7 to 9, there is a positive correlation between a width of the stereoscopic image in a direction corresponding to a direction along the multi-intersection arrangement line and a number of the light deflectors disposed along the multi-intersection arrangement line.

A display device according to aspect 11 of the disclosure includes the light guide plate according to aspect 1, a plurality of light sources that cause light to be incident on the light guide plate from the incident surface, and a controller that controls the plurality of light sources.

A display device according to aspect 12 of the disclosure is such that, in aspect 11, the plurality of light sources are linearly arranged, and the controller controls the plurality of light sources to be turned on and off sequentially from one end of the linear arrangement to the other end.

A display device according to aspect 13 of the disclosure is such that, in aspect 11, the plurality of light sources are linearly arranged, and the controller controls the plurality of light sources to be turned on and off sequentially from any point other than one end and the other end of the linear arrangement to both the one end and the other end.

A gaming machine according to aspect 14 of the disclosure includes a display device according to any one of aspects 11 to 13.

An in-vehicle displayer according to aspect 15 of the disclosure includes a display device according to any one of the aspects 11 to 13.

What is claimed is:

1. A light guide plate for displaying a stereoscopic image based on parallax, the light guide plate comprising:
an incident surface on which light from a light source is incident;
an emission surface from which the light is emitted; and
a plurality of light deflectors that deflect the light that is incident from the incident surface and guided and cause it to be emitted from the emission surface,
wherein the plurality of light deflectors are disposed on an arrangement line which is a linear arrangement region,
when a point on the emission surface from which a first emission light deflected by the light deflector is emitted into an angular range in which one eye and its vicinity of an observer observing the emission surface from within a predetermined range of observation space is irradiated is taken as a first emission point, and a point on the emission surface from which a second emission light deflected by the light deflector is emitted into an angular range in which the other eye and its vicinity of the observer is irradiated is taken as a second emission point, the plurality of light deflectors disposed on the arrangement line are provided such that a straight line passing through the first emission point and a center of the one eye and a straight line passing through the second emission point and a center of the other eye intersect with each other to form an intersection point, and
a plurality of the arrangement lines are provided, and at least one of the arrangement lines is a multi-intersection arrangement line in which the plurality of light deflectors are provided such that the intersection point is formed at multiple positions for each of the positions of the one eye and the other eye.

2. The light guide plate according to claim 1, wherein each of the plurality of light deflectors has a light deflection surface that deflects the light, and
the light deflection surface of the light deflector disposed on the multi-intersection arrangement line is a curved surface in which a direction in which the light emitted from one of the light source is deflected changes continuously from a first direction toward a first position in the observation space to a second direction toward a second position different from the first position.

3. The light guide plate according to claim 2, wherein a minimum value of light amount of light deflected by the light deflectors disposed on the multi-intersection arrangement line in accordance with a direction in which the light is deflected is 0.7 times or more a maximum value of the light amount.

4. The light guide plate according to claim 2, wherein an average light amount in an outer peripheral region of the stereoscopic image, of the light deflected by the light deflectors disposed on the multi-intersection arrangement line, is twice or more an average light amount in a region more inside of the stereoscopic image than the outer peripheral region, of the light deflected by the light deflectors disposed on the multi-intersection arrangement line.

5. The light guide plate according to claim 2, wherein the light deflector includes a first light deflector in which a curvature of the curved surface is a first curvature and a second light deflector in which the curvature is a second curvature different from the first curvature, and
a middle region is provided between a first light deflection region in which the first light deflector is disposed and a second light deflection region in which the second light deflector is disposed, in which the first light deflector and the second light deflector are disposed in a randomly mixed state.

6. The light guide plate according to claim 2,
wherein light amount of the light deflected by each of the plurality of light deflectors is constant for each of the multi-intersection arrangement lines on which the light deflectors are disposed, and
when a middle value in the middle of a maximum value and a minimum value of the light amount deflected by the light deflectors in a reference direction which is a direction in the middle of the first direction and the second direction is taken as a middle value,
the minimum value is 0.7 times or more the middle value, and the maximum value is 1.3 times or less the middle value.

7. The light guide plate according to claim 1,
wherein each of the light deflectors has a light deflection surface that deflects the light, and
directions in which the light deflection surfaces of the plurality of light deflectors disposed on the multi-intersection arrangement line deflect the light are dispersed between a first direction toward a first position in the observation space and a second direction toward a second position different from the first position.

8. The light guide plate according to claim 7, wherein a direction in which the light deflection surfaces of each of the plurality of light deflectors deflect the light are randomly dispersed between the first direction and the second direction.

9. The light guide plate according to claim 7,
wherein the plurality of light deflectors comprise:
a first light deflector group which is a collection of the light deflectors that deflect the light in the first direction with respect to the one eye and the other eye at any position;
a second light deflector group which is a collection of the light deflectors that deflect the light in the second direction with respect to the one eye and the other eye at any position; and
a third light deflector group that is a collection of the light deflectors that deflect the light in a random direction between the first direction and the second direction.

10. The light guide plate according to claim 7, wherein there is a positive correlation between a width of the stereoscopic image in a direction corresponding to a direction along the multi-intersection arrangement line and a number of the light deflectors disposed along the multi-intersection arrangement line.

11. A display device, comprising:
the light guide plate according to claim 1;
a plurality of light sources that cause light to be incident on the light guide plate from the incident surface; and
a controller that controls the plurality of light sources.

12. The display device according to claim 11,
wherein the plurality of light sources are linearly arranged, and
the controller controls the plurality of light sources to be turned on and off sequentially from one end of the linear arrangement to the other end.

13. The display device according to claim 11,
wherein the plurality of light sources are linearly arranged, and
the controller controls the plurality of light sources to be turned on and off sequentially from any point other than one end and the other end of the linear arrangement to both the one end and the other end.

14. A gaming machine comprising the display device according to claim 11.

15. A gaming machine comprising the display device according to claim 12.

16. A gaming machine comprising the display device according to claim 13.

17. An in-vehicle displayer comprising the display device according to claim 11.

18. An in-vehicle displayer comprising the display device according to claim 12.

19. An in-vehicle displayer comprising the display device according to claim 13.
